(19) United States
(12) Patent Application Publication
(10) Pub. No.: US 2025/0383565 A1
(43) Pub. Date: Dec. 18, 2025

(54) OPTICAL LAMINATE, DISPLAY DEVICE, AND SENSOR

(71) Applicant: FUJIFILM Corporation, Tokyo (JP)

(72) Inventors: Ayato SEKINE, Minamiashigara-shi (JP); Hiroshi SATO, Minamiashigara-shi (JP)

(73) Assignee: FUJIFILM Corporation, Tokyo (JP)

(21) Appl. No.: 19/317,213

(22) Filed: Sep. 3, 2025

Related U.S. Application Data
(63) Continuation of application No. PCT/JP2024/011704, filed on Mar. 25, 2024.

(30) Foreign Application Priority Data
Mar. 31, 2023 (JP) 2023-058102

(51) Int. Cl. G02F 1/1347

(52) U.S. Cl. CPC G02F 1/1347

(57) ABSTRACT

An object of the present invention is to provide an optical laminate including a plurality of liquid crystal layers having different alignment states of liquid crystal compounds and having a low reflectivity of a specular reflection component in a case where light is incident; a display device; and a sensor. The optical laminate of the present invention includes a first liquid crystal layer containing a liquid crystal compound and a second liquid crystal layer containing a liquid crystal compound, in which the first liquid crystal layer and the second liquid crystal layer are adjacent to each other, the first liquid crystal layer has a liquid crystal alignment pattern in which an orientation of an optical axis derived from the liquid crystal compound changes while continuously rotating in at least one in-plane direction, and predetermined requirements are satisfied.

### CROSS-REFERENCE TO RELATED APPLICATIONS

This application is a Continuation of PCT International Application No. PCT/JP2024/011704 filed on Mar. 25, 2024, which claims priority under 35 U.S.C. § 119 (a) to Japanese Patent Application No. 2023-058102 filed on Mar. 31, 2023. The above applications are hereby expressly incorporated by reference, in their entirety, into the present application.

### BACKGROUND OF THE INVENTION

### 1. Field of the Invention

The present invention relates to an optical laminate, a display device, and a sensor.

### 2. Description of the Related Art

An optical element which controls a direction of light has been used in various optical devices or systems.

For example, the optical element which controls a direction of light is used in various optical devices which display a virtual image, various information, or the like to be superimposed on a backlight unit of a liquid crystal display device and a scene which is actually being seen, for example, a head mounted display (HMD) such as augmented reality (AR) glasses, a projector, a beam steering device, and a sensor for detecting a thing or measuring the distance to a thing.

For example, WO2020/226080A discloses a liquid crystal diffraction element including a first cholesteric liquid crystal layer in which liquid crystal compounds are cholesterically aligned, and a second cholesteric liquid crystal layer which is laminated on the first cholesteric liquid crystal layer. In the liquid crystal diffraction element, the above-described two cholesteric liquid crystal layers are laminated with a pressure-sensitive adhesive layer interposed therebetween. In addition, single periods of liquid crystal alignment patterns are different between the first cholesteric liquid crystal layer and the second cholesteric liquid crystal layer.

### SUMMARY OF THE INVENTION

As a result of studying characteristics of the liquid crystal diffraction element disclosed in WO2020/226080A, it is found that reflectivity of a specular reflection component is high in a case where light was incident into the liquid crystal diffraction element, and it is necessary to improve the reflectivity.

As a result of further studies on the above-described problem, the present inventor has found that the above-described problem is remarkably generated in a case where two liquid crystal layers having different alignment states of liquid crystal compounds as described above are laminated with a pressure-sensitive adhesive layer interposed therebetween.

In consideration of the above-described circumstances, an object of the present invention is to provide an optical laminate including a plurality of liquid crystal layers having different alignment states of liquid crystal compounds and having a low reflectivity of a specular reflection component in a case where light is incident.

Another object of the present invention is to provide a display device and a sensor.

As a result of intensive studies repeatedly conducted by the present inventors on the above-described object, it has been found that the above-described object can be achieved by the following configurations.

(1) An optical laminate comprising:
a first liquid crystal layer containing a liquid crystal compound; and
a second liquid crystal layer containing a liquid crystal compound, in which the first liquid crystal layer and the second liquid crystal layer are adjacent to each other,
the first liquid crystal layer has a liquid crystal alignment pattern in which an orientation of an optical axis derived from the liquid crystal compound changes while continuously rotating in at least one in-plane direction, and
any one of requirements 1 to 3 described later is satisfied.

(2) The optical laminate according to (1),
in which a rotation angle of the optical axis derived from the liquid crystal compound in a thickness direction of the first liquid crystal layer is less than 360°.

(3) The optical laminate according to (2),
in which the requirement 1 or 2 described later is satisfied,
in a cross-sectional image obtained by observing a cross section of each of the first liquid crystal layer and the second liquid crystal layer taken in the thickness direction along the one direction with a scanning electron microscope, a plurality of pairs of bright lines and dark lines derived from the orientations of the optical axes are present along the one direction, and
the first liquid crystal layer and the second liquid crystal layer have a region where the pairs of bright lines and dark lines in the cross-sectional image are inclined at different inclination angles with respect to a normal line of an interface between the first liquid crystal layer and the second liquid crystal layer.

(4) The optical laminate according to (2),
in which, in a case where the length over which the orientation of the optical axis derived from the liquid crystal compound rotates by 180° in the plane is defined as a single period,
   a length of the single period in the liquid crystal alignment pattern of the first liquid crystal layer gradually changes in the one direction, and
   a length of the single period in the liquid crystal alignment pattern of the second liquid crystal layer gradually changes in the one direction.

(5) The optical laminate according to (1),
in which the first liquid crystal layer is a cholesteric liquid crystal layer.

(6) The optical laminate according to (5),
in which the requirement 1 or 2 described later is satisfied,
the second liquid crystal layer is a cholesteric liquid crystal layer, and
a helical pitch of a helical structure of a cholesteric liquid crystalline phase of the first liquid crystal layer and a helical pitch of a helical structure of a cholesteric liquid crystalline phase of the second liquid crystal layer are different from each other, or a rotation direction of the helical structure of the cholesteric liquid crystalline phase of the first liquid crystal layer and a rotation direction of the helical structure of the cholesteric liquid crystalline phase of the second liquid crystal layer are different from each other.

(7) The optical laminate according to (6),
in which, in a case where the length over which the orientation of the optical axis derived from the liquid crystal compound rotates by 180° in the plane is defined as a single period,
   a length of the single period in the liquid crystal alignment pattern of the first liquid crystal layer gradually changes in the one direction, and
   a length of the single period in the liquid crystal alignment pattern of the second liquid crystal layer gradually changes in the one direction.

(8) The optical laminate according to (1),
in which the requirement 3 described later is satisfied, and
the second liquid crystal layer is a λ/4 plate or a λ/2 plate.

(9) A display device comprising:
the optical laminate according to any one of (1) to (8).

(10) A sensor comprising:
the optical laminate according to any one of (1) to (8).

(11) The display device according to (9),
in which the display device is an augmented reality display device or a virtual reality display device.

According to the present invention, it is possible to provide an optical laminate including a plurality of liquid crystal layers having different alignment states of liquid crystal compounds and having a low reflectivity of a specular reflection component in a case where light is incident.

According to the present invention, it is possible to provide a display device and a sensor.

### BRIEF DESCRIPTION OF THE DRAWINGS

FIG. 1 is a side view conceptually showing an example of a first embodiment of the optical laminate according to the present invention.

FIG. 2 is a view for describing a liquid crystal alignment pattern of a first liquid crystal layer.

FIG. 3 is a view for describing a liquid crystal alignment pattern of a second liquid crystal layer.

FIG. 4 is a view showing a function of the first liquid crystal layer.

FIG. 5 is a view for describing a function of an example of the first embodiment of the optical laminate.

FIG. 6 is a side view conceptually showing another example of the first embodiment of the optical laminate according to the present invention.

FIG. 7 is a view for describing a function of still another example of the first embodiment of the optical laminate.

FIG. 8 is a side view conceptually showing an example of a second embodiment of the optical laminate according to the present invention.

FIG. 9 is a view for describing a liquid crystal alignment pattern of a first liquid crystal layer.

FIG. 10 is a view showing a function of the first liquid crystal layer.

FIG. 11 is a view showing a function of the first liquid crystal layer.

FIG. 12 is a view for describing a liquid crystal alignment pattern of a second liquid crystal layer.

FIG. 13 is a view for describing a function of the example of the second embodiment of the optical laminate.

FIG. 14 is a side view conceptually showing an example of a third embodiment of the optical laminate according to the present invention.

FIG. 15 is a view for describing a function of the example of the third embodiment of the optical laminate according to the present invention.

FIG. 16 is a side view conceptually showing another example of the third embodiment of the optical laminate according to the present invention.

FIG. 17 is a view for describing a function of still another example of the third embodiment of the optical laminate according to the present invention.

FIG. 18 is a conceptual view of an example of an exposure device which exposes an alignment film.

### DESCRIPTION OF THE PREFERRED EMBODIMENTS

Hereinafter, the present invention will be described in detail.

Although configuration requirements to be described below are described based on representative embodiments of the present invention, the present invention is not limited to the embodiments.

In the present specification, a numerical range represented by “to” means a range including numerical values before and after “to” as a lower limit value and an upper limit value.

In the present specification, for each component, one kind of substance corresponding to each component may be used alone, or two or more kinds thereof may be used in combination. Here, in a case where two or more kinds of substances are used in combination for each component, the content of the component indicates the total content of the substances used in combination, unless otherwise specified.

In the present specification, “(meth)acrylate” is used to mean “either or both of acrylate and methacrylate”.

In the present specification, visible light is light having a wavelength which can be seen by human eyes among electromagnetic waves, and refers to light in a wavelength range of 380 to 780 nm. Non-visible light refers to light in a wavelength range of less than 380 nm or more than 780 nm.

In addition, among the visible light, although not limited thereto, light in a wavelength range of 420 to 490 nm is blue light, light in a wavelength range of 495 to 570 nm is green light, and light in a wavelength range of 620 to 750 nm is red light.

A feature point of the optical laminate according to the embodiment of the present invention is that two liquid crystal layers having different alignment states of the liquid crystal compounds are disposed adjacent to each other. In the related art, the above-described two liquid crystal layers are laminated with a pressure-sensitive adhesive layer or the like interposed therebetween. Generally, since refractive indices of the liquid crystal layer and the pressure-sensitive adhesive layer are different from each other, the presence of the pressure-sensitive adhesive layer causes reflection to easily occur at an interface between the liquid crystal layers and the pressure-sensitive adhesive layer, and as a result, a specular reflection component is increased. On the other hand, in the present invention, the two liquid crystal layers are disposed adjacent to each other, so that the above-described problem is less likely to occur.

### First Embodiment

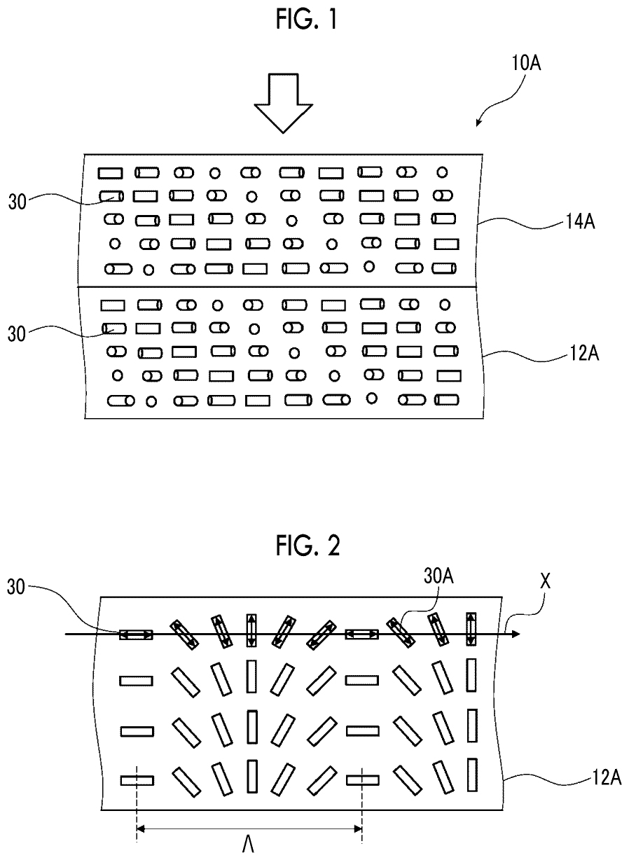

FIG. 1 is a side view conceptually showing an example of a first embodiment of the optical laminate according to the present invention. As will be described later, the first embodiment corresponds to an aspect in which both the first liquid crystal layer and the second liquid crystal layer are cholesteric liquid crystal layers. In addition, as will be described later, the example shown in FIG. 1 corresponds to an aspect in which the following requirement 1 is satisfied.

Requirement 1: the second liquid crystal layer has a liquid crystal alignment pattern in which an orientation of an optical axis derived from the liquid crystal compound changes while continuously rotating in at least one in-plane direction, and a rotation direction of the optical axis in the liquid crystal alignment pattern of the first liquid crystal layer is opposite to a rotation direction of the optical axis in the liquid crystal alignment pattern of the second liquid crystal layer.

An optical laminate 10A includes a first liquid crystal layer 12A which is a cholesteric liquid crystal layer and a second liquid crystal layer 14A which is a cholesteric liquid crystal layer. The first liquid crystal layer 12A and the second liquid crystal layer 14A are disposed adjacent to each other. The first liquid crystal layer 12A and the second liquid crystal layer 14A correspond to a layer obtained by fixing a cholesteric liquid crystalline phase. That is, both the first liquid crystal layer 12A and the second liquid crystal layer 14A are layers in which a liquid crystal compound is cholesterically aligned and immobilized.

FIG. 2 shows a plan view of the first liquid crystal layer 12A in the optical laminate 10A shown in FIG. 1. The plan view is a view in a case where, in FIG. 1, the first liquid crystal layer 12A is seen from above (in a direction of a white arrow), that is, FIG. 1 is a view in a case where the first liquid crystal layer 12A is seen from a thickness direction (=laminating direction of the respective layers (films)). In FIG. 2, in order to clearly show the configuration of the first liquid crystal layer 12A, only liquid crystal compounds 30 positioned in a surface of the first liquid crystal layer 12A on the second liquid crystal layer 14A side is shown.

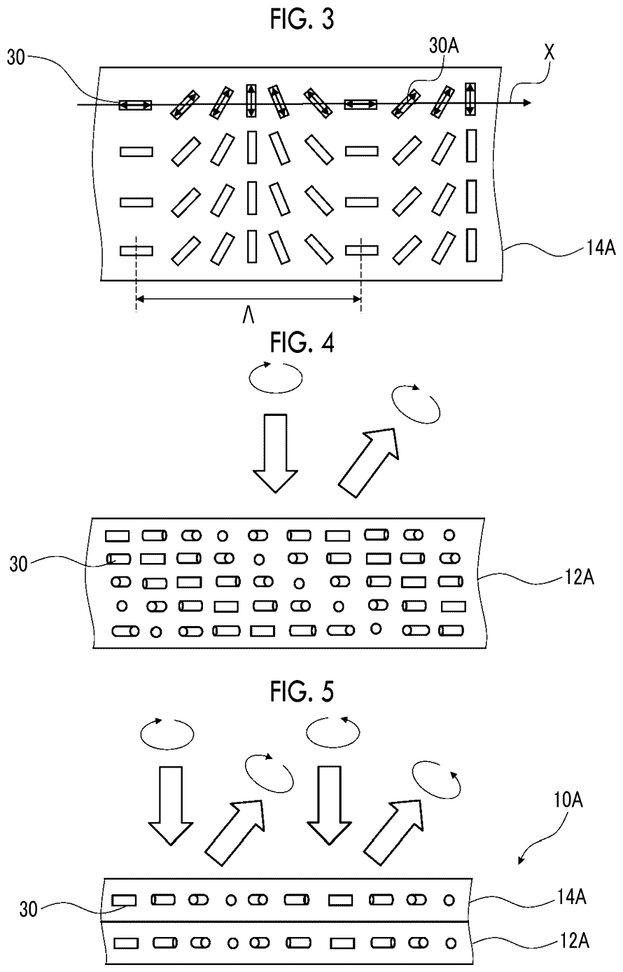

In addition, FIG. 3 shows a plan view of the second liquid crystal layer 14A in the optical laminate 10A shown in FIG. 1. The plan view is a view in a case where, in FIG. 1, the second liquid crystal layer 14A is seen from above (in a direction of a white arrow), that is, FIG. 1 is a view in a case where the second liquid crystal layer 14A is seen from a thickness direction (=laminating direction of the respective layers (films)). In FIG. 3, in order to clearly show the configuration of the second liquid crystal layer 14A, only liquid crystal compounds 30 positioned in a surface of the second liquid crystal layer 14A on the first liquid crystal layer 12A side is shown.

Similar to a typical cholesteric liquid crystal layer obtained by fixing a cholesteric liquid crystalline phase, the first liquid crystal layer 12A has a helical structure in which the liquid crystal compound 30 is turned and laminated along a helical axis in the thickness direction. In FIG. 1, the first liquid crystal layer 12A is shown in a simplified manner, but in the first liquid crystal layer 12A, a structure in which the liquid crystal compound 30 is turned and laminated in a helical manner once (rotated by 360°) is regarded as one helical pitch, and a plurality of the pitches of the liquid crystal compounds 30 turned in a helical manner are laminated. The same applies to the second liquid crystal layer 14A.

It is known that the cholesteric liquid crystalline phase exhibits selective reflectivity at a specific wavelength. A central wavelength λ of selective reflection (selective reflection central wavelength λ) depends on a pitch P (helical pitch) of the helical structure in the cholesteric liquid crystalline phase, and follows a relationship 2=n× P with an average refractive index n of the cholesteric liquid crystalline phase. Therefore, the selective reflection central wavelength can be adjusted by adjusting the pitch of the helical structure.

The helical pitch P is one pitch of the helical structure of the cholesteric liquid crystalline phase (helical period). In other words, the helical pitch P refers to one helical winding, that is, a length in a helical axis direction in which a director of the liquid crystal compound constituting the cholesteric liquid crystalline phase rotates by 360°. For example, in a case of rod-like liquid crystal, the director of the liquid crystal compound is a major axis direction.

The helical pitch of the cholesteric liquid crystalline phase depends on the type of the chiral agent used together with the liquid crystal compound or the addition concentration thereof in a case of forming the cholesteric liquid crystal layer, and thus a desired pitch can be obtained by adjusting these.

Regarding the adjustment of the pitch, detailed description can be referred to FUJIFILM Research Report No. 50 (2005), pp. 60 to 63. Regarding a method for measuring the helical sense and the pitch of the helix, it is possible to use the method described on page 46 of “Liquid Crystal Chemical Experiment Introduction” edited by Japan Liquid Crystal Society, published by Sigma Corporation in 2007, and page 196 of “Liquid Crystal Handbook” Liquid Crystal Handbook Editing Committee, Maruzen Publishing Co., Ltd.

In the present specification, the selective reflection central wavelength (for example, selective reflection central wavelength of the reflective layer and selective reflection central wavelength of the cholesteric liquid crystal layer) refers to an average value of two wavelengths indicating T1/2 (%): a half-value transmittance expressed by the following expression, in a case where the minimum value of the transmittance of a target object (a member) is defined as Tmin (%).

Expression for acquiring half-value transmittance: T1/2=100−[(100-Tmin)]÷2

The cholesteric liquid crystalline phase exhibits selective reflectivity with respect to left-handed or right-handed circular polarization at a specific wavelength. Whether or not the reflected light is dextrorotatory circularly polarized light or levorotatory circularly polarized light is determined depending on a helically twisted direction (sense) of the cholesteric liquid crystalline phase. Regarding the selective reflection of the circular polarization by the cholesteric liquid crystalline phase, in a case where the helically twisted direction of the cholesteric liquid crystalline phase is right, dextrorotatory circularly polarized light is reflected, and in a case where the helically twisted direction of the cholesteric liquid crystalline phase is left, levorotatory circularly polarized light is reflected.

The direction of revolution of the cholesteric liquid crystalline phase can be adjusted by the type of liquid crystal compound forming the cholesteric liquid crystal layer and/or the type of chiral agent added.

In addition, a half-width Δλ (nm) of a reflection wavelength range (circularly polarized light reflection range) in which the selective reflection occurs depends on a birefringence Δn of the cholesteric liquid crystal layer and the pitch P of the helix, and satisfies a relationship of Δλ=Δn×P. Therefore, by adjusting Δn, the width of the reflection wavelength range can be controlled. Δn can be adjusted by the type of liquid crystal compound forming a cholesteric liquid crystal layer and mixing ratio thereof, and the temperature during immobilizing the alignment.

The half-width of the reflection wavelength range is adjusted depending on the use of the optical laminate, and is, for example, preferably 10 to 500 nm, more preferably 20 to 300 nm, and still more preferably 30 to 150 nm.

As shown in FIGS. 1 to 3, both the first liquid crystal layer 12A and the second liquid crystal layer 14A have a liquid crystal alignment pattern in which an orientation of an optical axis 30A derived from the liquid crystal compound 30 changes while continuously rotating in one direction indicated by an arrow X. In the first liquid crystal layer 12A, the orientation of the optical axis 30A derived from the liquid crystal compound 30 changes while continuously rotating clockwise in the one direction indicated by the arrow X; and in the second liquid crystal layer 14A, the orientation of the optical axis 30A derived from the liquid crystal compound 30 changes while continuously rotating counterclockwise in the one direction indicated by the arrow X. That is, a rotation direction of the optical axis 30A derived from the liquid crystal compound 30 in the liquid crystal alignment pattern of the first liquid crystal layer 12A is opposite to a rotation direction of the optical axis 30A derived from the liquid crystal compound 30 in the liquid crystal alignment pattern of the second liquid crystal layer 14A.

The optical axis 30A derived from the liquid crystal compound 30 is an axis having the highest refractive index in the liquid crystal compound 30. For example, in a case where the liquid crystal compound 30 is a rod-like liquid crystal compound, the optical axis 30A is along a major axis direction of the rod shape.

In the following description, the “one direction indicated by an arrow X” will also be simply referred to as “arrow X direction”. In addition, in the following description, the optical axis 30A derived from the liquid crystal compound 30 will also be referred to as “optical axis 30A of the liquid crystal compound 30” or “optical axis 30A”.

In the first liquid crystal layer 12A, the liquid crystal compound 30 is two-dimensionally aligned in a plane parallel to the arrow X direction and a Y direction orthogonal to the arrow X direction. In addition, in the second liquid crystal layer 14A, the liquid crystal compound 30 is two-dimensionally aligned in a plane parallel to the arrow X direction and a Y direction orthogonal to the arrow X direction.

As described above, the first liquid crystal layer 12A has the liquid crystal alignment pattern in which the orientation of the optical axis 30A derived from the liquid crystal compound 30 changes while continuously rotating in the arrow X direction in the plane of the first liquid crystal layer 12A.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from 0 to 0+180° or to 0-180° in the arrow X direction.

A difference between the angles of the optical axes 30A of the liquid crystal compounds 30 adjacent to each other in the arrow X direction is preferably 45° or less, more preferably 15° or less, and still more preferably less than 15°.

Meanwhile, regarding the liquid crystal compound 30 forming the first liquid crystal layer 12A, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate.

In other words, regarding the liquid crystal compound 30 forming the first liquid crystal layer 12A, in the liquid crystal compounds 30 arranged in the Y direction, angles between the orientations of the optical axes 30A and the arrow X direction are the same.

In the optical laminate 10A, in such a liquid crystal alignment pattern of the liquid crystal compound 30, the length (distance) over which the optical axis 30A of the liquid crystal compound 30 rotates by 180° in the arrow X direction in which the direction of the optical axis 30A changes rotationally in a plane is defined as a length A of the single period in the liquid crystal alignment pattern. In other words, the length of the single period in the liquid crystal alignment pattern is defined as the distance between 0 and 0+180° that is a range of the angle between the optical axis 30A of the liquid crystal compound 30 and the arrow X direction.

That is, in the arrow X direction, a distance between centers of two liquid crystal compounds 30 having the same angle with respect to the arrow X direction is set as the length A of the single period. Specifically, as shown in FIG. 2, the distance between the centers of two liquid crystal compounds 30 in which the arrow X direction and the direction of the optical axis 30A coincide with each other in the arrow X direction is set as the length A of the single period. In the description below, the length A of the single period is also referred to as “single period Λ”.

In the first liquid crystal layer 12A, in the liquid crystal alignment pattern of the first liquid crystal layer 12A, the single period Λ is repeated in the arrow X direction, that is, in the one direction in which the orientation of the optical axis 30A changes while continuously rotating.

FIG. 3 is a plan view conceptually showing the second liquid crystal layer 14A, and the second liquid crystal layer 14A has the same configuration as the first liquid crystal layer 12A, except that the rotation direction of the optical axis 30A derived from the liquid crystal compound 30 in the liquid crystal alignment pattern of the second liquid crystal layer 14A is opposite to the rotation direction of the optical axis 30A derived from the liquid crystal compound 30 in the liquid crystal alignment pattern of the first liquid crystal layer 12A. Therefore, the description thereof will be omitted.

That is, the single period Λ of the liquid crystal alignment pattern of the first liquid crystal layer 12A and the single period Λ of the liquid crystal alignment pattern of the second liquid crystal layer 14A are the same. In addition, the helical pitch P of the helical structure of the first liquid crystal layer 12A and the helical pitch P of the helical structure of the second liquid crystal layer 14A are the same.

The cholesteric liquid crystal layer formed by fixing the cholesteric liquid crystalline phase normally reflects incident light (circularly polarized light) by specular reflection.

On the other hand, the first liquid crystal layer 12A having the above-described liquid crystal alignment pattern reflects incident light in a direction having an angle in the X direction with respect to the specular reflection. Specifically, as shown in FIG. 4, the first liquid crystal layer 12A reflects light (in FIG. 4, dextrorotatory circularly polarized light) incident from the normal direction in a state in which the light is tilted with respect to the normal direction instead of being reflected in the normal direction. The light incident from the normal direction refers to light incident from the front side, that is, light incident to be perpendicular to the main surface. The main surface refers to the maximum surface of the sheet-shaped material.

A reflection angle of light from the first liquid crystal layer 12A, in which the optical axis 30A of the liquid crystal compound 30 continuously rotates in one direction (X direction), varies depending on wavelengths of light to be reflected. Specifically, as the wavelength of light increases, the angle of reflected light with respect to the incident light increases.

In addition, a reflection angle of light from the first liquid crystal layer 12A, in which the optical axis 30A of the liquid crystal compound 30 continuously rotates in the one direction (X direction), varies depending on the length A of the single period of the liquid crystal alignment pattern, over which the optical axis 30A rotates by 180° in the X direction, that is, depending on the single period Λ. Specifically, as the single period Λ decreases, the angle of reflected light with respect to the incident light increases.

The above-described single period Λ is not particularly limited and may be appropriately set depending on the use of the optical laminate 10A and the like. For example, the single period Λ is preferably 50 μm or less, and more preferably 10 μm or less. In consideration of accuracy or the like of the liquid crystal alignment pattern, the single period Λ is preferably 0.1 μm or more.

The second liquid crystal layer 14A also has the liquid crystal alignment pattern in which the optical axis 30A changes while continuously rotating in the X direction (the predetermined one direction) in a plane.

Therefore, the second liquid crystal layer 14A reflects incident light in a direction having an angle in the X direction with respect to specular reflection. However, in the second liquid crystal layer 14A, levorotatory circularly polarized light is reflected in a state in which the light is tilted with respect to the normal direction instead of being reflected in the normal direction.

In FIG. 5, a case where dextrorotatory circularly polarized light and levorotatory circularly polarized light are incident on the optical laminate 10A from the normal direction will be described. In FIG. 5, the configurations of the first liquid crystal layer 12A and the second liquid crystal layer 14A are shown in a simplified manner.

In a case where the dextrorotatory circularly polarized light is incident on the optical laminate 10A, as shown in FIG. 4, the dextrorotatory circularly polarized light is reflected in a direction having a predetermined angle with respect to the X direction by the action of the first liquid crystal layer 12A. In addition, in a case where the levorotatory circularly polarized light is incident on the optical laminate 10A, the levorotatory circularly polarized light is reflected in a direction having a predetermined angle with respect to the X direction by the action of the second liquid crystal layer 14A.

Accordingly, both the dextrorotatory circularly polarized light and the levorotatory circularly polarized light can be reflected in the same angular direction. That is, the optical laminate 10A can diffract different circularly polarized light components at the same angle.

In the optical laminate 10A, the first liquid crystal layer 12A and the second liquid crystal layer 14A are disposed adjacent to each other, so that the reflectivity of the specular reflection component is low.

In the optical laminate 10A shown in FIG. 1, the single period Λ of the liquid crystal alignment pattern of the first liquid crystal layer 12A and the single period Λ of the liquid crystal alignment pattern of the second liquid crystal layer 14A are the same; but the present invention is not limited to this aspect. That is, in the first embodiment of the optical laminate, the single period Λ of the liquid crystal alignment pattern of the first liquid crystal layer and the single period Λ of the liquid crystal alignment pattern of the second liquid crystal layer may be different from each other.

By adjusting the single period Λ, a reflection angle of reflected light can be adjusted. In addition, in the first embodiment of the optical laminate, the length of the single period Λ in the liquid crystal alignment pattern of the first liquid crystal layer may gradually change in the X direction (one direction). For example, the length of the single period Λ in the liquid crystal alignment pattern of the first liquid crystal layer may gradually decrease or increase in the X direction (one direction).

In addition, in the first embodiment of the optical laminate, the length of the single period Λ in the liquid crystal alignment pattern of the second liquid crystal layer may gradually change in the X direction (one direction). For example, the length of the single period Λ in the liquid crystal alignment pattern of the second liquid crystal layer may gradually decrease or increase in the X direction (one direction).

In the optical laminate 10A shown in FIG. 1, the helical pitch P of the helical structure of the first liquid crystal layer 12A and the helical pitch P of the helical structure of the second liquid crystal layer 14A are the same; but the present invention is not limited to this aspect. That is, in the first embodiment of the optical laminate, the helical pitch P of the helical structure of the first liquid crystal layer and the helical pitch P of the helical structure of the second liquid crystal layer may be different from each other.

By adjusting the helical pitch P, a wavelength of reflected light can be adjusted.

In addition, in the first embodiment of the optical laminate, the helical pitch P of the helical structure of the first liquid crystal layer may gradually change in the thickness direction. For example, the helical pitch P of the helical structure of the first liquid crystal layer may gradually increase or decrease in the thickness direction.

In addition, in the first embodiment of the optical laminate, the helical pitch P of the helical structure of the second liquid crystal layer may gradually change in the thickness direction. For example, the helical pitch P of the helical structure of the second liquid crystal layer may gradually increase or decrease in the thickness direction.

In the optical laminate 10A shown in FIG. 1, the rotation direction of the helical structure of the first liquid crystal layer 12A and the rotation direction of the helical structure of the second liquid crystal layer 14A are opposite to each other; but the present invention is not limited to this aspect. That is, in the first embodiment of the optical laminate, the rotation direction of the helical structure of the first liquid crystal layer and the rotation direction of the helical structure of the second liquid crystal layer may be the same.

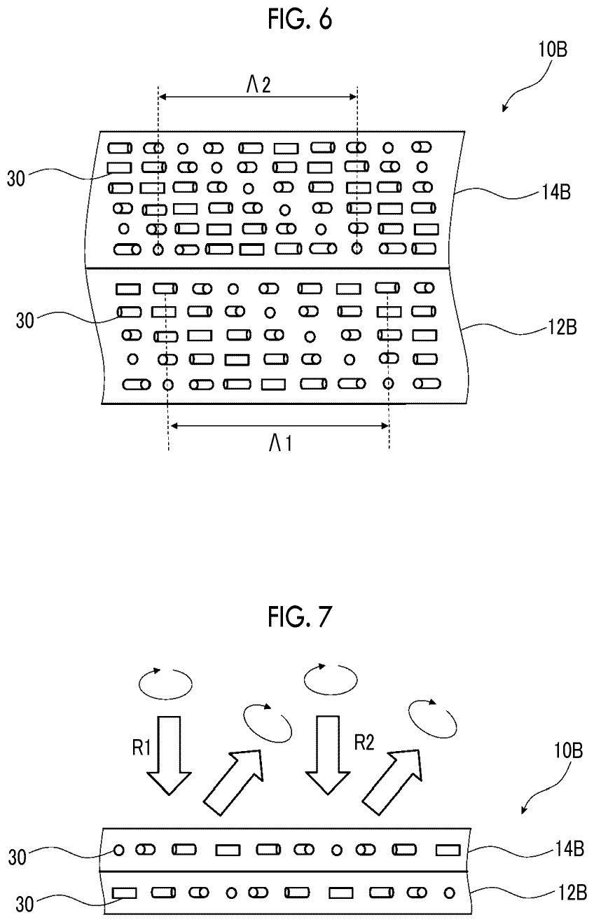

In the optical laminate 10A shown in FIG. 1, the rotation direction of the optical axis 30A derived from the liquid crystal compound 30 in the liquid crystal alignment pattern of the first liquid crystal layer 12A and the rotation direction of the optical axis 30A derived from the liquid crystal compound 30 in the liquid crystal alignment pattern of the second liquid crystal layer 14A are opposite to each other; but the present invention is not limited to this aspect. That is, in the first embodiment of the optical laminate, as shown in FIG. 6 described later, the rotation direction of the optical axis derived from the liquid crystal compound in the liquid crystal alignment pattern of the first liquid crystal layer and the rotation direction of the optical axis derived from the liquid crystal compound in the liquid crystal alignment pattern of the second liquid crystal layer may be the same.

As described above, the single period Λ of the liquid crystal alignment pattern, the helical pitch P of the helical structure, the rotation direction of the helical structure, and the rotation direction of the optical axis derived from the liquid crystal compound in the liquid crystal alignment pattern are not limited to those in FIG. 1, and can be appropriately adjusted.

FIG. 6 is a side view conceptually showing another example of the first embodiment of the optical laminate according to the present invention. As will be described later, the example shown in FIG. 6 corresponds to an aspect in which the following requirement 2 is satisfied.

Requirement 2: the second liquid crystal layer has a liquid crystal alignment pattern in which an orientation of an optical axis derived from the liquid crystal compound changes while continuously rotating in at least one in-plane direction, and a length over which the orientation of the optical axis derived from the liquid crystal compound in the liquid crystal alignment pattern of the first liquid crystal layer rotates by 180° in a plane differs from a length over which the orientation of the optical axis derived from the liquid crystal compound in the liquid crystal alignment pattern of the second liquid crystal layer rotates by 180° in a plane.

An optical laminate 10B includes a first liquid crystal layer 12B which is a cholesteric liquid crystal layer and a second liquid crystal layer 14B which is a cholesteric liquid crystal layer. The first liquid crystal layer 12B and the second liquid crystal layer 14B are disposed adjacent to each other. The first liquid crystal layer 12B and the second liquid crystal layer 14B correspond to a layer obtained by fixing a cholesteric liquid crystalline phase.

Both the first liquid crystal layer 12B and the second liquid crystal layer 14B have a helical structure which is turned and laminated along the helical axis in the thickness direction, and have the above-described liquid crystal alignment pattern as in the first liquid crystal layer 12A and the second liquid crystal layer 14A.

On the other hand, the rotation direction of the optical axis derived from the liquid crystal compound in the liquid crystal alignment pattern of the first liquid crystal layer 12B and the rotation direction of the optical axis derived from the liquid crystal compound in the liquid crystal alignment pattern of the second liquid crystal layer 14B are the same. In addition, the rotation direction of the helical structure of the first liquid crystal layer 12B and the rotation direction of the helical structure of the second liquid crystal layer 14B are the same.

Furthermore, the helical pitch P of the helical structure of the first liquid crystal layer 12B is different from the helical pitch P of the helical structure of the first liquid crystal layer 12B, in which the helical pitch P of the helical structure of the first liquid crystal layer 12B is larger than the helical pitch P of the helical structure of the second liquid crystal layer 14B. In addition, a length of a single period Λ1 in the liquid crystal alignment pattern of the first liquid crystal layer 12B is longer than a length of a single period Λ 2 in the liquid crystal alignment pattern of the second liquid crystal layer 14B.

Both the first liquid crystal layer 12B and the second liquid crystal layer 14B reflect circularly polarized light having the same turning direction, and a wavelength of light reflected from the first liquid crystal layer 12B is longer than a wavelength of light reflected from the second liquid crystal layer 14B.

In FIG. 7, a case where dextrorotatory circularly polarized light R1 and dextrorotatory circularly polarized light R2 having different wavelengths are incident on the optical laminate 10B from the normal direction will be described. In FIG. 7, the configurations of the first liquid crystal layer 12B and the second liquid crystal layer 14B are shown in a simplified manner. In addition, the first liquid crystal layer 12B reflects the dextrorotatory circularly polarized light R1, and the second liquid crystal layer 14B reflects the dextrorotatory circularly polarized light R2.

In this case, in a case where the dextrorotatory circularly polarized light R1 and the dextrorotatory circularly polarized light R2 having different wavelengths are incident on the optical laminate 10B, as shown in FIG. 7, the two dextrorotatory circularly polarized light components can be reflected in the same direction by the action of the first liquid crystal layer 12B and the second liquid crystal layer 14B.

### Second Embodiment

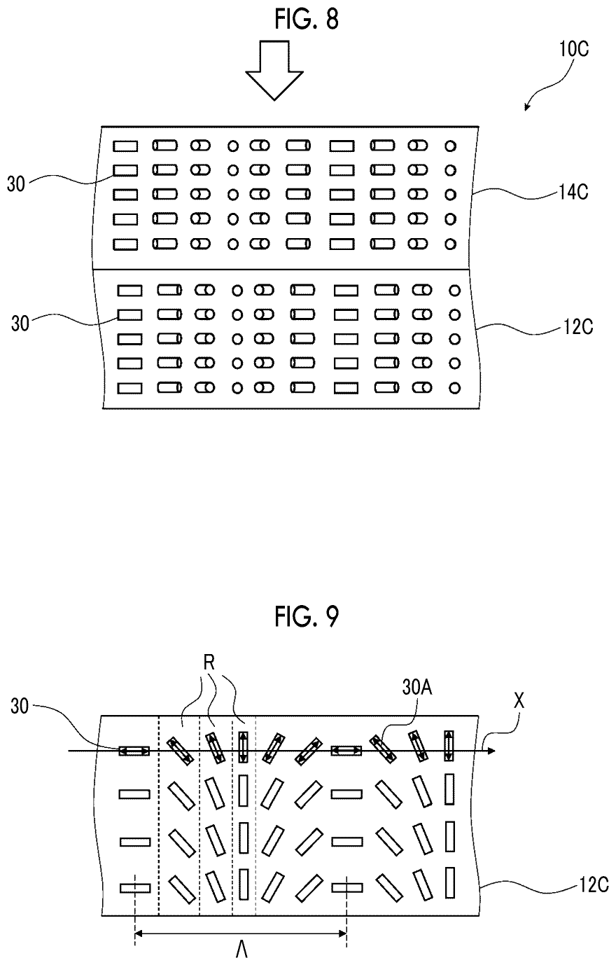

FIG. 8 is a side view conceptually showing an example of a second embodiment of the optical laminate according to the present invention. As described later, the second embodiment corresponds to an aspect in which neither the first liquid crystal layer nor the second liquid crystal layer has a liquid crystal compound twisted and aligned in a thickness direction, or a rotation angle of an optical axis derived from the liquid crystal compound in the thickness direction is less than 360°.

In addition, as will be described later, the example shown in FIG. 8 corresponds to an aspect in which the following requirement 1 is satisfied.

Requirement 1: the second liquid crystal layer has a liquid crystal alignment pattern in which an orientation of an optical axis derived from the liquid crystal compound changes while continuously rotating in at least one in-plane direction, and a rotation direction of the optical axis in the liquid crystal alignment pattern of the first liquid crystal layer is opposite to a rotation direction of the optical axis in the liquid crystal alignment pattern of the second liquid crystal layer.

An optical laminate 10C includes a first liquid crystal layer 12C and a second liquid crystal layer 14C. The first liquid crystal layer 12C and the second liquid crystal layer 14C are disposed adjacent to each other.

FIG. 9 shows a plan view of the first liquid crystal layer 12C in the optical laminate 10C shown in FIG. 8. The plan view is a view in a case where, in FIG. 8, the first liquid crystal layer 12C is seen from above (in a direction of a white arrow), that is, FIG. 9 is a view in a case where the first liquid crystal layer 12C is seen from a thickness direction (=laminating direction of the respective layers (films)). In FIG. 9, in order to clearly show the configuration of the first liquid crystal layer 12C, only liquid crystal compounds 30 positioned in a surface of the first liquid crystal layer 12C on the second liquid crystal layer 14C side is shown.

In addition, FIG. 10 shows a plan view of the second liquid crystal layer 14C in the optical laminate 10C shown in FIG. 8. The plan view is a view in a case where, in FIG. 8, the second liquid crystal layer 14C is seen from above (in a direction of a white arrow), that is, FIG. 10 is a view in a case where the second liquid crystal layer 14C is seen from a thickness direction (=laminating direction of the respective layers (films)). In FIG. 10, in order to clearly show the configuration of the second liquid crystal layer 14C, only liquid crystal compounds 30 positioned in a surface of the second liquid crystal layer 14C on the first liquid crystal layer 12C side is shown.

Both the first liquid crystal layer 12C and the second liquid crystal layer 14C are formed of a liquid crystal composition containing a liquid crystal compound. In the first liquid crystal layer 12C and the second liquid crystal layer 14C, the liquid crystal compound is immobilized.

The first liquid crystal layer 12C has a liquid crystal alignment pattern in which an orientation of the optical axis 30A derived from the liquid crystal compound 30 changes while continuously rotating clockwise in one direction indicated by an arrow X in a plane of the first liquid crystal layer 12C.

The optical axis 30A derived from the liquid crystal compound 30 is an axis having the highest refractive index in the liquid crystal compound 30. For example, in a case where the liquid crystal compound 30 is a rod-like liquid crystal compound, the optical axis 30A is along a major axis direction of the rod shape.

In the following description, the “one direction indicated by an arrow X” will also be simply referred to as “arrow X direction”. In addition, in the following description, the optical axis 30A derived from the liquid crystal compound 30 will also be referred to as “optical axis 30A of the liquid crystal compound 30” or “optical axis 30A”.

In the first liquid crystal layer 12C, the liquid crystal compound 30 is two-dimensionally aligned in a plane parallel to the arrow X direction and a Y direction orthogonal to the arrow X direction. In addition, in the second liquid crystal layer 14C, the liquid crystal compound 30 is two-dimensionally aligned in a plane parallel to the arrow X direction and a Y direction orthogonal to the arrow X direction.

The first liquid crystal layer 12C has the liquid crystal alignment pattern in which the orientation of the optical axis 30A derived from the liquid crystal compound 30 changes while continuously rotating in the arrow X direction in the plane of the first liquid crystal layer 12C.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from 0 to 0+180° or to 0-180° in the arrow X direction.

A difference between the angles of the optical axes 30A of the liquid crystal compounds 30 adjacent to each other in the arrow X direction is preferably 45° or less, more preferably 15° or less, and still more preferably less than 15°.

Meanwhile, regarding the liquid crystal compound 30 forming the first liquid crystal layer 12C, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate.

In other words, regarding the liquid crystal compound 30 forming the first liquid crystal layer 12C, in the liquid crystal compounds 30 arranged in the Y direction, angles between the orientations of the optical axes 30A and the arrow X direction are the same.

In the first liquid crystal layer 12C, in such a liquid crystal alignment pattern of the liquid crystal compound 30, the length (distance) over which the optical axis 30A of the liquid crystal compound 30 rotates by 180° in the arrow X direction in which the direction of the optical axis 30A changes rotationally in a plane is defined as a length A of the single period in the liquid crystal alignment pattern. In other words, the length of the single period in the liquid crystal alignment pattern is defined as the distance between 0 and 0+180° that is a range of the angle between the optical axis 30A of the liquid crystal compound 30 and the arrow X direction.

That is, in the arrow X direction, a distance between centers of two liquid crystal compounds 30 having the same angle with respect to the arrow X direction is set as the length A of the single period. Specifically, as shown in FIG. 9, the distance between the centers of two liquid crystal compounds 30 in which the arrow X direction and the direction of the optical axis 30A coincide with each other in the arrow X direction is set as the length A of the single period. In the description below, the length A of the single period is also referred to as “single period Λ”.

In the first liquid crystal layer 12C, in the liquid crystal alignment pattern of the first liquid crystal layer 12C, the single period Λ is repeated in the arrow X direction, that is, in the one direction in which the orientation of the optical axis 30A changes while continuously rotating.

As described above, in the first liquid crystal layer 12C, the liquid crystal compounds 30 arranged in the Y direction have the same angle between the optical axis 30A and the arrow X direction (one direction in which the orientation of the optical axis of the liquid crystal compound 30 rotates). A region where the liquid crystal compounds 30 in which the angles between the optical axes 30A and the arrow X direction are the same are arranged in the Y direction will be referred to as a region R.

In this case, it is preferable that an in-plane retardation (Re) value of each of the regions R is a half wavelength, that is, λ/2. The in-plane retardation is calculated from a product of a difference in refractive index Δn due to refractive index anisotropy of the region R and a thickness of the first liquid crystal layer 12C. Here, the difference in refractive index due to the refractive index anisotropy of the regions R in the first liquid crystal layer 12C is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the above-described difference in refractive index Δn is the same as the difference in refractive index of the liquid crystal compound.

In a case where circularly polarized light is incident into the first liquid crystal layer 12C, the light is refracted and a direction of the circularly polarized light is changed.

This action is conceptually shown in FIG. 10 with the first liquid crystal layer 12C as an example. In the first liquid crystal layer 12C, a value of a product of a difference in refractive index of the liquid crystal compound and a thickness of the first liquid crystal layer 12C is set to λ/2. In FIG. 10, the number of liquid crystal compounds 30 in the first liquid crystal layer 12C is reduced for simplification of the drawing.

As shown in FIG. 10, in a case where the value of the product of the difference in refractive index of the liquid crystal compound of the first liquid crystal layer 12C and the thickness of the first liquid crystal layer 12C is λ/2, and an incidence ray L₁ as levorotatory circularly polarized light is incident into the first liquid crystal layer 12C, the incidence ray L₁ transmits through the first liquid crystal layer 12C to be imparted with a retardation of 180°, and thus is converted into a transmitted ray L₂ as dextrorotatory circularly polarized light.

In addition, in a case where the incidence ray L₁ transmits through the first liquid crystal layer 12C, an absolute phase thereof changes depending on the orientation of the optical axis 30A of each liquid crystal compound 30. At this time, since the orientation of the optical axis 30A changes while rotating in the arrow X direction, an amount of change in absolute phase of the incidence ray L₁ varies depending on the orientation of the optical axis 30A. Furthermore, the liquid crystal alignment pattern formed in the first liquid crystal layer 12C is a pattern which is periodic in the arrow X direction. Therefore, as shown in FIG. 10, the incidence ray L₁ transmitted through the first liquid crystal layer 12C is imparted with an absolute phase Q1 which is periodic in the arrow X direction corresponding to the orientation of each optical axis 30A. As a result, an equiphase plane E1 which is tilted in a direction opposite to the arrow X direction is formed.

Therefore, the transmitted ray L₂ is refracted to be tilted in a direction perpendicular to the equiphase plane E1, and travels in a direction different from a traveling direction of the incidence ray L₁. In this way, the incidence ray L₁ of the levorotatory circularly polarized light is converted into the transmitted ray L₂ of the dextrorotatory circularly polarized light, which is tilted by a predetermined angle in the arrow X direction with respect to an incidence direction.

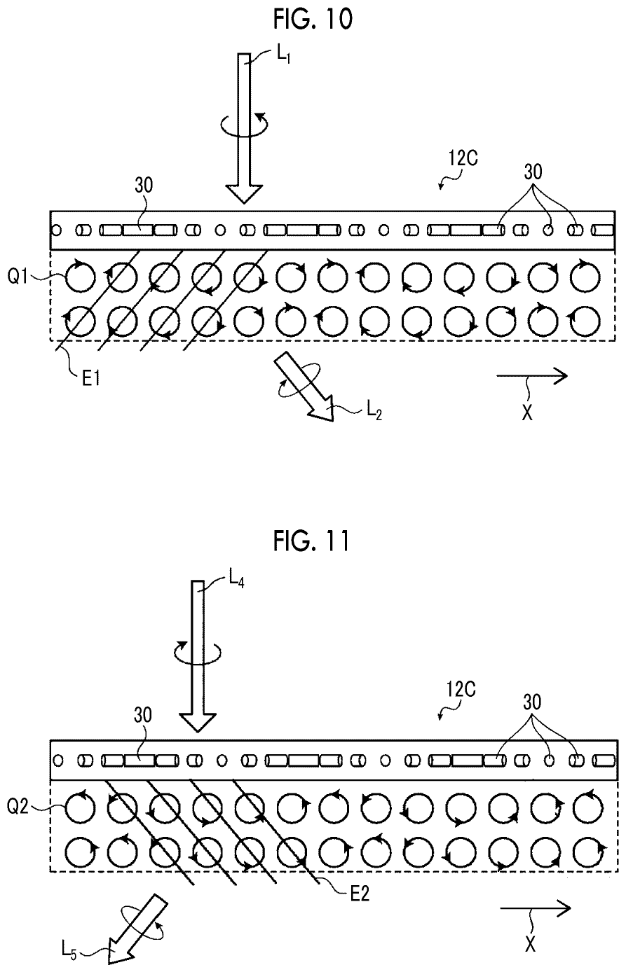

On the other hand, as conceptually shown in FIG. 11, in a case where the value of the product of the difference in refractive index of the liquid crystal compound of the first liquid crystal layer 12C and the thickness of the first liquid crystal layer 12C is λ/2, and an incidence ray La as dextrorotatory circularly polarized light is incident into the first liquid crystal layer 12C, the incidence ray La transmits through the first liquid crystal layer 12C to be imparted with a retardation of 180°, and thus is converted into a transmitted ray L₅ as levorotatory circularly polarized light.

In addition, in a case where the incidence ray La transmits through the first liquid crystal layer 12C, an absolute phase thereof changes depending on the orientation of the optical axis 30A of each liquid crystal compound 30. At this time, since the orientation of the optical axis 30A changes while rotating in the arrow X direction, an amount of change in absolute phase of the incidence ray La varies depending on the orientation of the optical axis 30A. Furthermore, the liquid crystal alignment pattern formed in the first liquid crystal layer 12C is a pattern which is periodic in the arrow X direction. Therefore, as shown in FIG. 10, the incidence ray La transmitted through the first liquid crystal layer 12C is imparted with an absolute phase Q2 which is periodic in the arrow X direction corresponding to the orientation of each optical axis 30A.

Here, since the incidence ray La is dextrorotatory circularly polarized light, the absolute phase Q2 which is periodic in the arrow X direction corresponding to the orientation of the optical axis 30A is opposite to the incidence ray L₁ as levorotatory circularly polarized light. As a result, in the incidence ray L₄, an equiphase plane E2 which is tilted in the arrow X direction opposite to that of the incidence ray L₁ is formed.

Therefore, the incidence ray La is refracted to be tilted in a direction perpendicular to the equiphase plane E2, and travels in a direction different from a traveling direction of the incidence ray L₄. In this way, the incidence ray La is converted into the transmitted ray L₅ of the levorotatory circularly polarized light, which is tilted by a predetermined angle in the arrow X direction with respect to a direction opposite to the incidence direction.

In the first liquid crystal layer 12C, it is preferable that the in-plane retardation value of the plurality of the regions R is a half wavelength, and it is preferable that an in-plane retardation Re (550)=Δn₅₅₀×d of the plurality of the regions R of the first liquid crystal layer 12C with respect to an incidence ray having a wavelength of 550 nm is in a range defined by the following expression (1). Here, Δn₅₅₀ is a difference in refractive index due to the refractive index anisotropy of the region R in a case where the wavelength of the incident light is 550 nm, and d represents a thickness of the first liquid crystal layer 12C.

$$200 nm \leq Δ {n}_{550} \times d \leq 350 nm \qquad ( 1 )$$

That is, in a case where the in-plane retardation Re (550)=Δn₅₅₀×d of the plurality of the regions R of the first liquid crystal layer 12C satisfies the expression (1), a sufficient amount of circularly polarized light components of light which has been incident into the first liquid crystal layer 12C can be converted into circularly polarized light traveling in a direction tilted in a forward or backward direction with respect to the arrow X direction. It is more preferable that the in-plane retardation Re (550)=Δn₅₅₀× d is 225 nm≤Δn₅₅₀× d≤340 nm, and it is still more preferable that the in-plane retardation Re (550)=Δn₅₅₀× d is 250 nm≤ Δn₅₅₀× d≤330 nm.

The above expression (1) is a range with respect to the incident light having a wavelength of 550 nm, but an in-plane retardation Re (2)=Δnλ×d of the plurality of the regions R of the first liquid crystal layer 12C with respect to incident light having a wavelength of λ nm is preferably in a range defined by the following expression (1-2), and can be appropriately set.

$$0 \text{.7} λ nm \leq Δ n λ \times d \leq 1.3 λ nm \qquad ( 1 ‐ 2 )$$

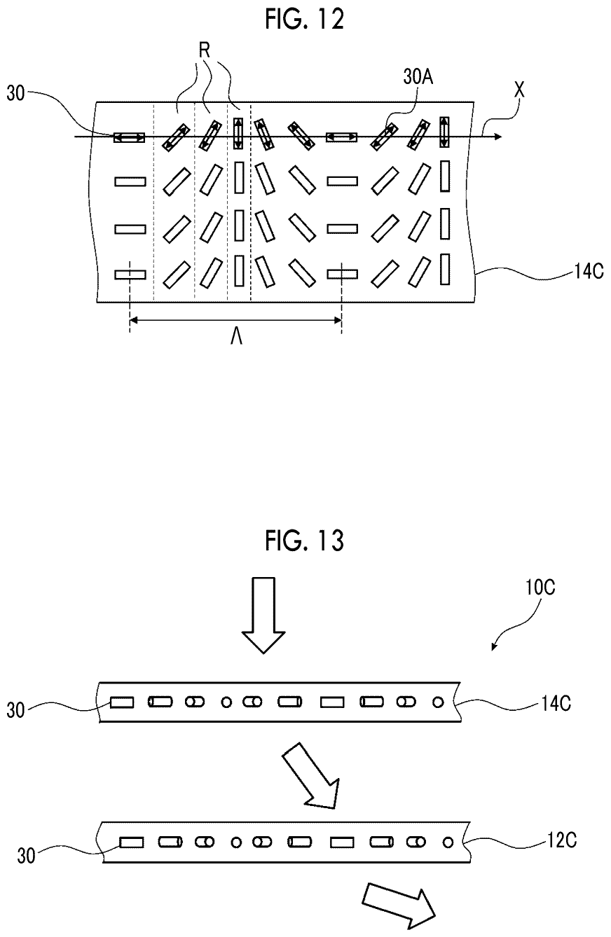

FIG. 12 is a plan view conceptually showing the second liquid crystal layer 14C, and the second liquid crystal layer 14C has the same configuration as the first liquid crystal layer 12C, except that the rotation direction of the optical axis 30A derived from the liquid crystal compound 30 in the liquid crystal alignment pattern of the second liquid crystal layer 14C is opposite to the rotation direction of the optical axis 30A derived from the liquid crystal compound 30 in the liquid crystal alignment pattern of the second liquid crystal layer 14C. Therefore, the description thereof will be omitted.

That is, the single period Λ of the liquid crystal alignment pattern of the first liquid crystal layer 12C and the single period Λ of the liquid crystal alignment pattern of the second liquid crystal layer 14C are the same.

In FIG. 13, a case where levorotatory circularly polarized light is incident on the optical laminate 10C from the normal direction will be described. In FIG. 13, the configurations of the first liquid crystal layer 12C and the second liquid crystal layer 14C are shown in a simplified manner.

In a case where the levorotatory circularly polarized light is incident on the optical laminate 10C, first, as shown in FIG. 13, dextrorotatory circularly polarized light is incident in a direction tilted at a certain angle by the action of the second liquid crystal layer 14C. Next, in a case where dextrorotatory circularly polarized light is incident into the first liquid crystal layer 12C, as shown in FIG. 13, levorotatory circularly polarized light is emitted in a direction tilted at a certain angle by the action of the first liquid crystal layer 12C.

That is, by using the optical laminate 10C, a diffraction angle of incident light can be increased.

In the optical laminate 10C, the first liquid crystal layer 12C and the second liquid crystal layer 14C are disposed adjacent to each other, so that the reflectivity of the specular reflection component is low.

In the optical laminate 10C shown in FIG. 8, the single period Λ of the liquid crystal alignment pattern of the first liquid crystal layer 12C and the single period Λ of the liquid crystal alignment pattern of the second liquid crystal layer 14C are the same; but the present invention is not limited to this aspect. That is, in the second embodiment of the present invention, the single period Λ of the liquid crystal alignment pattern of the first liquid crystal layer and the single period Λ of the liquid crystal alignment pattern of the second liquid crystal layer may be different from each other. That is, the above-described requirement 2 may be satisfied.

By adjusting the single period Λ, a diffraction angle of diffracted light can be adjusted.

In addition, in the second embodiment of the present invention, the length of the single period Λ in the liquid crystal alignment pattern of the first liquid crystal layer may gradually change in the X direction (one direction). For example, the length of the single period Λ in the liquid crystal alignment pattern of the first liquid crystal layer may gradually decrease or increase in the X direction (one direction).

In addition, in the second embodiment of the present invention, the length of the single period Λ in the liquid crystal alignment pattern of the second liquid crystal layer may gradually change in the X direction (one direction). For example, the length of the single period Λ in the liquid crystal alignment pattern of the second liquid crystal layer may gradually decrease or increase in the X direction (one direction).

The above-described single period Λ is not particularly limited and may be appropriately set depending on the use of the optical laminate 10C and the like. For example, the single period Λ is preferably 50 μm or less, and more preferably 10 μm or less. In consideration of accuracy or the like of the liquid crystal alignment pattern, the single period Λ is preferably 0.1 μm or more.

In the optical laminate 10C shown in FIG. 8, the rotation direction of the optical axis 30A derived from the liquid crystal compound 30 in the liquid crystal alignment pattern of the first liquid crystal layer 12C and the rotation direction of the optical axis 30A derived from the liquid crystal compound 30 in the liquid crystal alignment pattern of the second liquid crystal layer 14C are opposite to each other; but the present invention is not limited to this aspect. For example, in the second embodiment of the present invention, the above-described requirement 2 may be satisfied, and the rotation direction of the optical axis derived from the liquid crystal compound in the liquid crystal alignment pattern of the first liquid crystal layer and the rotation direction of the optical axis derived from the liquid crystal compound in the liquid crystal alignment pattern of the second liquid crystal layer may be the same.

In the optical laminate 10C shown in FIG. 8, the liquid crystal compound 30 in the first liquid crystal layer 12C and the liquid crystal compound in the second liquid crystal layer 14C are aligned along the same direction in the thickness direction; but the present invention is not limited to this aspect.

In the second embodiment of the present invention, in the first liquid crystal layer, the liquid crystal compound may be twisted and aligned along the thickness direction, and for example, a rotation angle of the optical axis derived from the liquid crystal compound of the first liquid crystal layer in the thickness direction may be less than 360°.

In the second embodiment of the present invention, in the second liquid crystal layer, the liquid crystal compound may be twisted and aligned along the thickness direction, and for example, a rotation angle of the optical axis derived from the liquid crystal compound of the second liquid crystal layer in the thickness direction may be less than 360°.

In the case of the cholesteric alignment in the first embodiment described above, the twisted angle is 360° or more, and the cholesteric liquid crystal layer has selective reflectivity of reflecting specific circularly polarized light in a specific wavelength range. The “twisted alignment” in the present specification does not include the cholesteric alignment, and selective reflectivity does not occur in the liquid crystal layer having the twisted alignment.

The twisted angle of the liquid crystal compound 30 in the thickness direction is preferably approximately 10° to 200°, and more preferably approximately 45° to 180°.

In addition, in a cross-sectional image obtained by observing, with a scanning electron microscope, a cross section of each of the first liquid crystal layer and the second liquid crystal layer taken in the thickness direction along the one direction in which the liquid crystal alignment pattern extends, a plurality of pairs of bright lines and dark lines derived from the orientations of the optical axes may be present along the one direction, and the first liquid crystal layer and the second liquid crystal layer may have a region where the pairs of bright lines and dark lines in the cross-sectional image are inclined at different inclination angles with respect to a normal line of an interface between the first liquid crystal layer and the second liquid crystal layer.

The expression “bright lines and dark lines derived from the orientations of the optical axes” refers to bright and dark lines observed according to the alignment state of the liquid crystal compound of the liquid crystal layer in the thickness direction.

### Third Embodiment

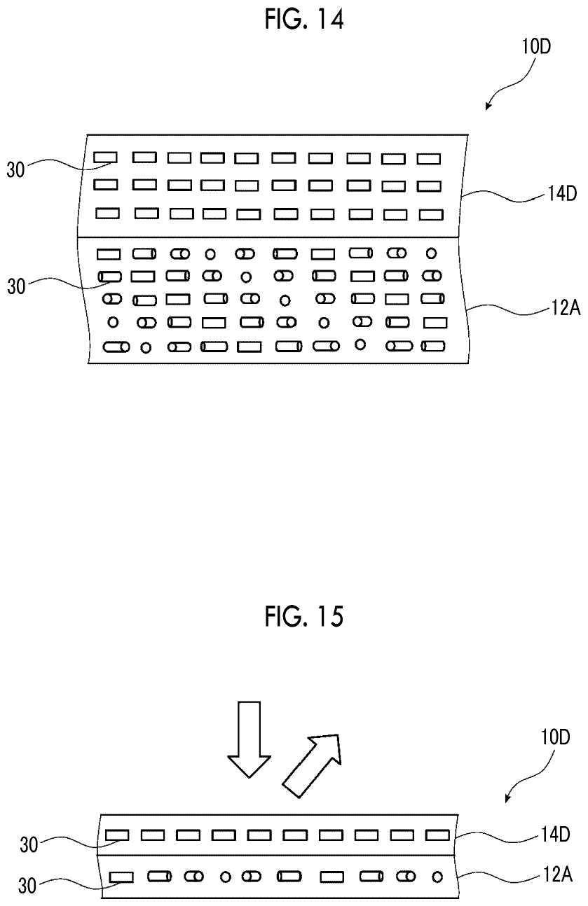

FIG. 14 is a side view conceptually showing an example of a third embodiment of the optical laminate according to the present invention. As will be described later, the third embodiment corresponds to an aspect in which a requirement 3 is satisfied.

Requirement 3: the liquid crystal compound in the second liquid crystal layer is aligned along one direction in a surface on the first liquid crystal layer side.

An optical laminate 10D includes a first liquid crystal layer 12A and a second liquid crystal layer 14D. The first liquid crystal layer 12A and the second liquid crystal layer 14D are disposed adjacent to each other. In the first liquid crystal layer 12A and the second liquid crystal layer 14D, the liquid crystal compound is immobilized.

The first liquid crystal layer 12A included in the optical laminate 10D has the same configuration as the first liquid crystal layer 12A shown in FIG. 1 described above.

The second liquid crystal layer 14D is a layer containing a liquid crystal compound 30 homogeneously aligned. That is, in the second liquid crystal layer 14D, the liquid crystal compound 30 is aligned in one direction. The second liquid crystal layer 14D is a layer which functions as a so-called 24 plate.

The λ/4 plate is a plate having a function of converting linearly polarized light having a specific wavelength into circularly polarized light (or circularly polarized light into linearly polarized light). More specifically, the λ/4 plate is a plate in which the in-plane retardation Re at a predetermined wavelength λ nm is λ/4 (or an odd multiple thereof).

An in-plane retardation (Re (550)) of the λ/4 plate at a wavelength of 550 nm may have an error of approximately 25 nm based on an ideal value (137.5 nm), and is, for example, preferably 110 to 160 nm and more preferably 120 to 150 nm.

In FIG. 15, a case where linearly polarized light is incident on the optical laminate 10D from the normal direction will be described. In FIG. 15, the configurations of the first liquid crystal layer 12A and the second liquid crystal layer 14D are shown in a simplified manner.

In a case where the linearly polarized light is incident on the optical laminate 10D, first, the linearly polarized light is converted into dextrorotatory circularly polarized light by the action of the second liquid crystal layer 14D functioning as the λ/4 plate. Next, in a case where the dextrorotatory circularly polarized light is incident into the first liquid crystal layer 12A, dextrorotatory circularly polarized light is emitted in a direction tilted at a certain angle by the action of the first liquid crystal layer 12A. The emitted dextrorotatory circularly polarized light is incident into the second liquid crystal layer 14D again, and is emitted as linearly polarized light.

That is, by using the optical laminate 10D, linearly polarized light can be diffracted with high diffraction efficiency.

In the optical laminate 10D, the first liquid crystal layer 12A and the second liquid crystal layer 14D are disposed adjacent to each other, so that the reflectivity of the specular reflection component is low.

In FIG. 14, a layer functioning as a λ/4 plate is used as the second liquid crystal layer 14D; but the present invention is not limited to this aspect.

A λ/2 plate may be used as the above-described second liquid crystal layer.

The λ/2 plate refers to an optically anisotropic film in which an in-plane retardation Re (2) at a specific wavelength of A nm satisfies Re (2)≈λ/2. This expression may be achieved at any wavelength (for example, 550 nm) in the visible light region. Among these, it is preferable that the in-plane retardation Re (550) at a wavelength of 550 nm satisfies the following relationship.

$$210 mm \leq Re ( 550 ) \leq 300 mm$$

In addition, a cholesteric liquid crystal layer may be used as the above-described second liquid crystal layer.

The configuration of the first liquid crystal layer 12A included in the optical laminate 10D is not limited to the configuration shown in FIG. 14. As described above, the single period Λ of the liquid crystal alignment pattern, the helical pitch P of the helical structure, the rotation direction of the helical structure, and the rotation direction of the optical axis derived from the liquid crystal compound in the liquid crystal alignment pattern can be appropriately adjusted.

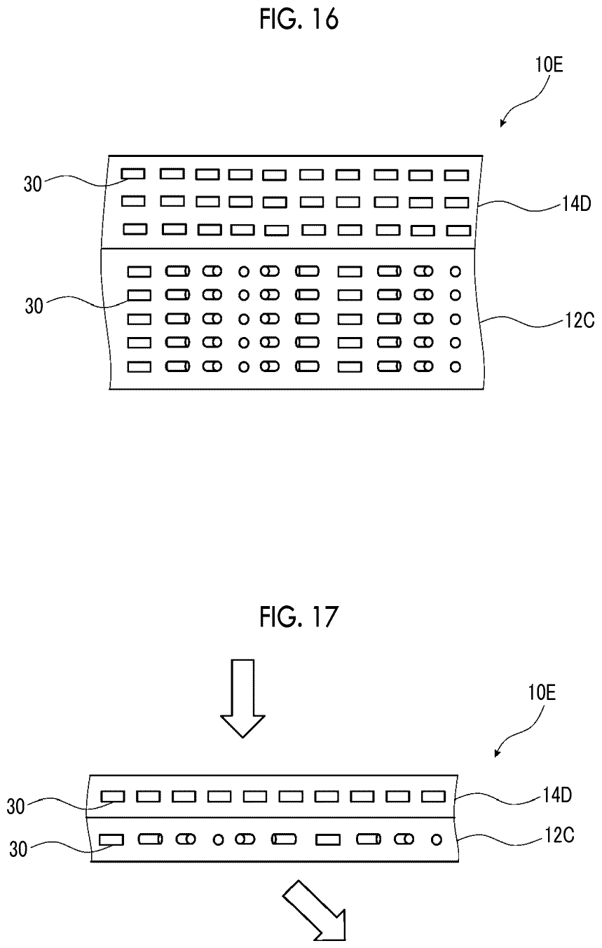

FIG. 16 is a side view conceptually showing another example of the third embodiment of the optical laminate according to the present invention.

An optical laminate 10E includes a first liquid crystal layer 12C and a second liquid crystal layer 14D. The first liquid crystal layer 12C and the second liquid crystal layer 14D are disposed adjacent to each other.

The first liquid crystal layer 12C included in the optical laminate 10E has the same configuration as the first liquid crystal layer 12C shown in FIG. 8 described above.

The second liquid crystal layer 14D included in the optical laminate 10E has the same configuration as the second liquid crystal layer 14D shown in FIG. 14 described above.

In FIG. 17, a case where linearly polarized light is incident on the optical laminate 10E from the normal direction will be described. In FIG. 17, the configurations of the first liquid crystal layer 12C and the second liquid crystal layer 14D are shown in a simplified manner.

In a case where the linearly polarized light is incident on the optical laminate 10E, first, the linearly polarized light is converted into levorotatory circularly polarized light by the action of the second liquid crystal layer 14D functioning as the λ/4 plate. Next, in a case where the levorotatory circularly polarized light is incident into the first liquid crystal layer 12C, dextrorotatory circularly polarized light is emitted in a direction tilted at a certain angle by the action of the first liquid crystal layer 12C.

That is, by using the optical laminate 10E, linearly polarized light can be diffracted with high diffraction efficiency.

In the optical laminate 10E, the first liquid crystal layer 12C and the second liquid crystal layer 14D are disposed adjacent to each other, so that the reflectivity of the specular reflection component is low.

In FIG. 16, a layer functioning as a λ/4 plate is used as the second liquid crystal layer 14D; but the present invention is not limited to this aspect.

A λ/2 plate or a cholesteric liquid crystal layer may be used as the above-described second liquid crystal layer.

The configuration of the first liquid crystal layer 12C included in the optical laminate 10E is not limited to the configuration shown in FIG. 16. As described above, the single period Λ of the liquid crystal alignment pattern and the rotation direction of the optical axis derived from the liquid crystal compound in the liquid crystal alignment pattern can be appropriately adjusted.

As described above, the optical laminates 10A to 10E satisfy any one of the requirements 1 to 3.

Whether or not the requirements 1 to 3 are satisfied can be confirmed by observing a cross section of the optical laminate with a scanning electron microscope.

Regarding the requirement 1, whether or not the requirement is satisfied can be confirmed by evaluating optical characteristics of the optical laminate by causing light to be incident on the optical laminate. For example, in the case of the configuration of the optical laminate 10A described above, in a case where the dextrorotatory circularly polarized light and the levorotatory circularly polarized light are incident on the optical laminate, the dextrorotatory circularly polarized light and the levorotatory circularly polarized light are reflected in the same direction. Therefore, by evaluating optical characteristics, it is possible to check whether or not the optical laminate has the configuration of the optical laminate 10A. In addition, for example, in a case where the diffraction angle is larger than the diffraction angle estimated from the in-plane pattern period of the observed cross section when the circularly polarized light is incident into the optical laminate, it is possible to check whether or not the optical laminate has the configuration of the optical laminate 10C.

An average thickness of each of the first liquid crystal layer and the second liquid crystal layer included in the above-described optical laminates is not particularly limited, and an optimum thickness is selected according to various uses. For example, the average thickness is preferably 0.05 to 50 μm, more preferably 0.1 to 40 μm, still more preferably 0.2 to 30 μm, and particularly preferably 0.3 to 15 μm.

In addition, the average thicknesses of the first liquid crystal layer and the second liquid crystal layer may vary depending on the application.

In a device application for a visible light range (for example, approximately 400 to approximately 700 nm), the average thicknesses of the first liquid crystal layer and the second liquid crystal layer are preferably 0.05 to 15 μm, more preferably 0.1 to 10 μm, still more preferably 0.2 to 8 μm, and particularly preferably 0.3 to 5 μm.

In addition, in a device application for an IR light range (for example, approximately 800 to 2,500 nm), the average thicknesses of the first liquid crystal layer and the second liquid crystal layer are preferably 0.2 to 50 μm, more preferably 0.5 to 40 μm, still more preferably 1 to 30 μm, and particularly preferably 3 to 15 μm.

The above-described average thickness of the first liquid crystal layer is obtained by measuring thicknesses at 10 positions of the first liquid crystal layer and arithmetically averaging the measured values.

In addition, the above-described average thickness of the second liquid crystal layer is obtained by measuring thicknesses at 10 positions of the second liquid crystal layer and arithmetically averaging the measured values.

### <Other Members>

The above-described optical laminate may include a member other than the first liquid crystal layer and the second liquid crystal layer.

### (Support)

The optical laminate may include a support.

As the support, various sheet-like materials (film-like or plate-like materials) can be used as long as the support can support the first liquid crystal layer and the second liquid crystal layer.

A transmittance of the support with respect to corresponding light is preferably 50% or more, more preferably 70% or more, and still more preferably 85% or more.

A thickness of the support is not limited, and may be appropriately set depending on the application of the optical laminate, the material for forming the support, and the like.

The thickness of the support is preferably 1 to 1,000 μm, more preferably 3 to 250 μm, and still more preferably 5 to 150 μm.

The support may be single-layered or multi-layered.

In a case where the support has a monolayer structure, examples thereof include supports formed of glass, triacetyl cellulose, polyethylene terephthalate, polycarbonates, polyvinyl chloride, poly (meth)acrylate, polyolefin, and the like. In a case where the support has a multi-layer structure, examples thereof include a support including one of the above-described supports having a monolayer structure, which is provided as a substrate, and another layer which is provided on a surface of the substrate.

### (Alignment Film)

The optical laminate may include an alignment film.

It is preferable that the first liquid crystal layer and the second liquid crystal layer are formed on the alignment film. In addition, the alignment film may be used as an alignment film for forming the above-described liquid crystal alignment pattern.

As the alignment film, various known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as @-tricosanoic acid, dioctadecylmethylammonium chloride, or methyl stearate.

The alignment film formed by a rubbing treatment can be formed by rubbing a surface of a polymer layer with paper or fabric in a given direction multiple times.

As the material used for the alignment film, a material for forming polyimide, polyvinyl alcohol, a polymer having a polymerizable group described in JP1997-152509A (JP-H9-152509A), or an alignment film and the like described in JP2005-097377A, JP2005-099228A, and JP2005-128503A is preferable.

As the alignment film, a so-called photo-alignment film obtained by irradiating a material having photo alignment with polarized light or non-polarized light is suitably used. That is, in the optical laminate, a photo-alignment film which is formed by applying a photo-alignment material onto the support is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the photo-alignment film which can be used in the present invention include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitability used.

A thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method for forming the alignment film is not limited, and various known methods can be used depending on the material for forming the alignment film. Examples thereof include a method including: applying the alignment film to a surface of the support; drying the applied alignment film; and exposing the alignment film to laser light to form an alignment pattern.

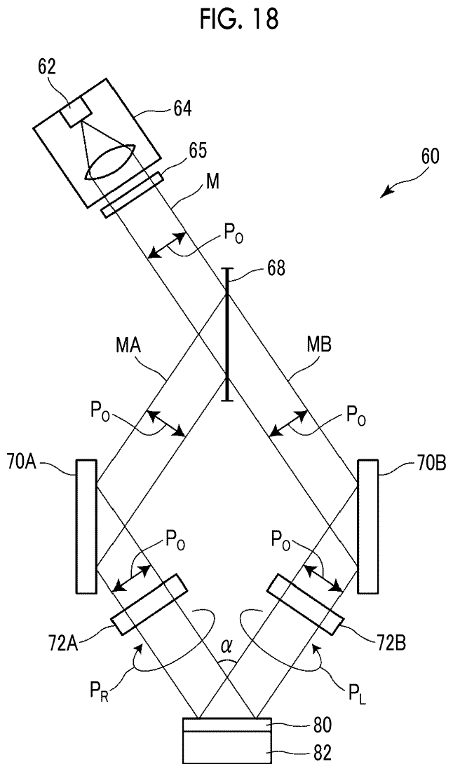

FIG. 18 conceptually shows an example of an exposure device which exposes the alignment film to form an alignment pattern.

An exposure device 60 shown in FIG. 18 includes a light source 64 including a laser 62, an λ/2 plate 65 which changes a polarization direction of a laser light M emitted from the laser 62, a polarization beam splitter 68 which splits the laser light M emitted from the laser 62 into two beams MA and MB, mirrors 70A and 70B which are each disposed on an optical path of the splitted two beams MA and MB, and λ/4 plates 72A and 72B. Although not shown in the drawing, the light source 64 emits linearly polarized light P₀. The λ/4 plate 72A converts the linearly polarized light P₀ (ray MA) into dextrorotatory circularly polarized light PR, and the λ/4 plate 72B converts the linearly polarized light P₀ (ray MB) into levorotatory circularly polarized light P_{L}.

The λ/4 plates 72A and 72B used here may be λ/4 plates corresponding to a wavelength of light to be emitted. Since the exposure device 60 emits the laser light M, for example, in a case where a central wavelength of the laser light M is 325 nm, a λ/4 plate which functions with respect to light having a wavelength of 325 nm may be used.

The support 82 including the alignment film 80 on which the alignment pattern is not yet formed is disposed at an exposed portion, the two rays MA and MB intersect and interfere each other on the alignment film 80, and the alignment film 80 is irradiated with and exposed to the interference light.

Due to the interference at this time, the polarization state of light with which the alignment film 80 is irradiated periodically changes according to interference fringes. As a result, in the alignment film 80, an alignment pattern in which the alignment state periodically changes can be obtained.

In the exposure device 60, by changing an intersecting angle α between the two rays MA and MB, a period of the alignment pattern can be adjusted. That is, by adjusting the intersecting angle α in the exposure device 60, in the alignment pattern in which the optical axis derived from the liquid crystal compound continuously rotates in the one direction, it is possible to adjust a length of the single period over which the optical axis rotates by 180° in the one direction that the optical axis rotates.

By forming the cholesteric liquid crystal layer on the alignment film having the alignment pattern in which the alignment state periodically changes, as described above, the cholesteric liquid crystal layer having the liquid crystal alignment pattern in which the optical axis derived from the liquid crystal compound continuously rotates in the one direction can be formed. In addition, by rotating the optical axes of the λ/4 plates 72A and 72B by 90°, respectively, the rotation direction of the optical axis can be reversed.

### <Method for Manufacturing Optical Laminate>

A method for manufacturing the optical laminate is not particularly limited, and a known method can be adopted.

In particular, a method of using a photo-alignment polymer (hereinafter, also referred to as “cleavage group-containing photo-alignment polymer”) having a repeating unit including a photo-aligned group and a repeating unit including a cleavage group which decomposes by action of at least one selected from the group consisting of light, heat, acid, and base to generate a polar group is preferable.

More specifically, a method for manufacturing an optical laminate, including the following steps 1 to 4, is preferable.

Step 1: a step of forming a coating film using a composition for forming the first liquid crystal layer, the composition containing a liquid crystal compound, a cleavage group-containing photo-alignment polymer, and a photoacid generator

Step 2: a step of aligning the liquid crystal compound in the coating film obtained in the step 1, and performing a curing treatment and an acid generation treatment to form the first liquid crystal layer

Step 3: step of subjecting the first liquid crystal layer obtained in the step 2 to a photo-alignment treatment

Step 4: a step of applying a composition for forming the second liquid crystal layer, containing a liquid crystal compound, onto the first liquid crystal layer obtained in the step 3 to form the second liquid crystal layer

Hereinafter, the procedure of the above-described steps 1 to 4 will be specifically described.

### (Step 1)

The step 1 is a step of forming a coating film using a composition for forming the first liquid crystal layer, the composition containing a liquid crystal compound, a cleavage group-containing photo-alignment polymer, and a photoacid generator.

Hereinafter, first, the materials used in the present step will be described in detail.

### [Liquid Crystal Compound]

As such a liquid crystal compound, both a low-molecular-weight liquid crystal compound and a polymer liquid crystal compound can be used. Here, the “low-molecular-weight liquid crystal compound” denotes a liquid crystal compound having no repeating units in the chemical structure. In addition, the “high-molecular-weight liquid crystal compound” refers to a liquid crystal compound having a repeating unit in the chemical structure.

Examples of the low-molecular-weight liquid crystal compound include liquid crystal compounds described in JP2013-228706A.

Examples of the high-molecular-weight liquid crystal compound include thermotropic liquid crystal polymers described in JP2011-237513A and WO2019/131943A. In addition, the high-molecular-weight liquid crystal compound may include a crosslinkable group (such as an acryloyl group and a methacryloyl group) at a terminal.

The liquid crystal compound may be used alone or in combination of two or more kinds thereof.

As the liquid crystal compound, a liquid crystal compound having a polymerizable group is preferable. Examples of the polymerizable group include an unsaturated polymerizable group, an epoxy group, and an aziridinyl group; and among these, an unsaturated polymerizable group is preferable, and an ethylenically unsaturated polymerizable group is more preferable.

The liquid crystal compound may be a rod-like liquid crystal compound or a disk-like liquid crystal compound.

As described above, in the first liquid crystal layer and the second liquid crystal layer of the optical laminate, the liquid crystal compound may be immobilized. In order to immobilize the liquid crystal compound, there is a method of immobilizing the liquid crystal compound by polymerizing the polymerizable group using the above-described liquid crystal compound having a polymerizable group.

A content of the liquid crystal compound in the composition for forming the first liquid crystal layer is preferably 75% to 99.9% by mass, more preferably 80% to 99% by mass, and still more preferably 85% to 90% by mass with respect to the solid content mass of the liquid crystal composition.

The solid content of the liquid crystal composition is intended to be a component of the liquid crystal composition, excluding a solvent. Even in a case where a component is liquid, it is calculated as the solid content.

### [Cleavage Group-Containing Photo-Alignment Polymer]

The cleavage group-containing photo-alignment polymer has a repeating unit including a photo-aligned group, and a repeating unit including a cleavage group which decomposes by action of at least one selected from the group consisting of light, heat, acid, and base to generate a polar group.

Examples of the repeating unit including a photo-aligned group in the cleavage group-containing photo-alignment polymer include a repeating unit represented by Formula (A) (hereinafter, also abbreviated as “repeating unit A”).

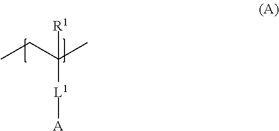

In Formula (A), R¹ represents a hydrogen atom or a substituent, L¹ represents a divalent linking group, and A represents a photo-aligned group.

Next, the hydrogen atom or the substituent represented by R¹ in Formula (A) will be described.

In Formula (A), as the substituent represented as one aspect of R¹, a halogen atom, a linear alkyl group having 1 to 20 carbon atoms, a branched or cyclic alkyl group having 3 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, or an amino group is preferable. Next, the divalent linking group represented by L₁ in Formula (A) will be described.

As the divalent linking group, a divalent linking group obtained by combining at least two or more groups selected from the group consisting of a linear alkylene group having 1 to 18 carbon atoms, which may have a substituent, a branched or cyclic alkylene group having 3 to 18 carbon atoms, which may have a substituent, an arylene group having 6 to 12 carbon atoms, which may have a substituent, an ether group (—O—), a carbonyl group (—C(═O)—), and an imino group (—NH—), which may have a substituent, is preferable.

Here, examples of the substituent which may be included in the alkylene group, the arylene group, and the imino group include a halogen atom, an alkyl group, an alkoxy group, an aryl group, an aryloxy group, a cyano group, a carboxy group, an alkoxycarbonyl group, and a hydroxyl group.

Examples of the halogen atom include a fluorine atom, a chlorine atom, a bromine atom, and an iodine atom; and among these, a fluorine atom or a chlorine atom is preferable.

In addition, the number of carbon atoms in the alkyl group is preferably 1 to 18, the number of carbon atoms in the alkoxy group is preferably 1 to 18, and the number of carbon atoms in the aryl group is preferably 6 to 12.

L₁ in Formula (A) preferably represents a divalent linking group including a cycloalkane ring, and preferably represents a divalent linking group including a nitrogen atom and a cycloalkane ring.

In the suitable aspect, a part of carbon atoms constituting the cycloalkane ring may be substituted with a heteroatom selected from the group consisting of nitrogen, oxygen, and sulfur. In addition, in a case where a part of carbon atoms constituting the cycloalkane ring is substituted with a nitrogen atom, no nitrogen atom may be included separately from the cycloalkane ring.

Here, a cycloalkane ring having 6 or more carbon atoms is preferable as the cycloalkane ring, and specific examples thereof include a cyclohexane ring, a cycloheptane ring, a cyclooctane ring, a cyclododecane ring, and a cyclodocosane ring.

In addition, from the viewpoint of improving aligning properties of the above-described liquid crystal compound, it is preferable that L¹ in Formula (A) is a divalent linking group represented by any one of Formulae (3) to (12).

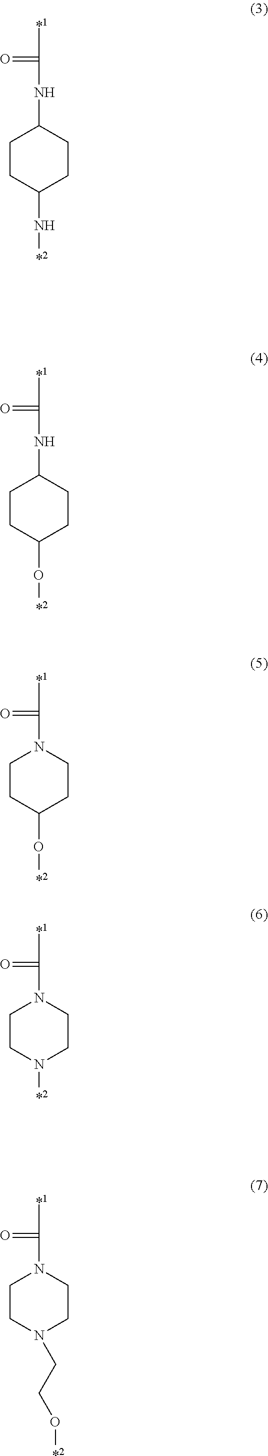

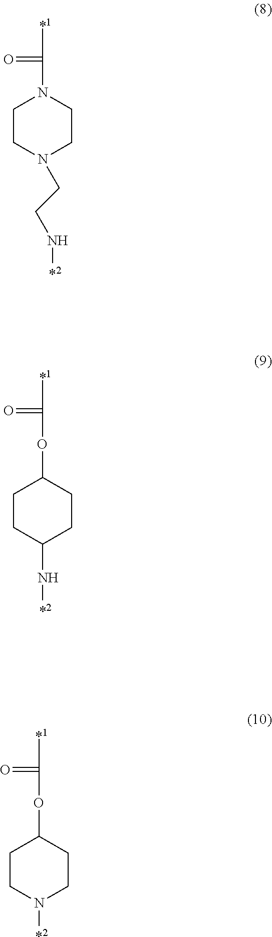

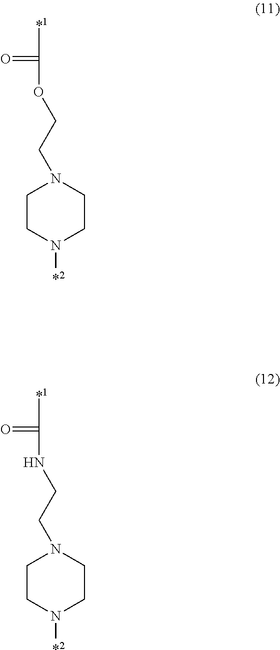

In Formulae (3) to (12), *1 represents a bonding position to a carbon atom to which R¹ in Formula (A) is bonded, and *2 represents a bonding position to A in Formula (A).

Among the divalent linking groups represented by any one of Formulae (3) to (12), from the viewpoint of improving the balance between solubility in a solvent and solvent resistance of the obtained liquid crystal layer, a divalent linking group represented by any one of Formula (4), (5), (9), or (10) is preferable.

Next, the photo-aligned group represented by A in Formula (A) will be described.

From the reason that thermal stability or chemical stability of a monomer having the photo-aligned group is good, the photo-aligned group is preferably a group which undergoes at least one of dimerization or isomerization by action of light.

Suitable specific examples of the group which is dimerized by the action of light include groups having a skeleton of at least one derivative selected from the group consisting of a cinnamic acid derivative, a coumarin derivative, a chalcone derivative, a maleimide derivative, and a benzophenone derivative.

On the other hand, suitable specific examples of the group which is isomerized by the action of light include groups having a skeleton of at least one compound selected from the group consisting of an azobenzene compound, a stilbene compound, a spiropyran compound, a cinnamic acid compound, and a hydrazono-β-ketoester compound.

Among such photo-aligned groups, a group having a skeleton of at least one derivative or compound selected from the group consisting of a cinnamic acid derivative, a coumarin derivative, a chalcone derivative, a maleimide derivative, an azobenzene compound, a stilbene compound, and a spiropyran compound is preferable; and among these, from the reason that the above-described aligning properties of the liquid crystal compound are improved, a group having a skeleton of a cinnamic acid derivative or an azobenzene compound is more preferable, and a group having a skeleton of a cinnamic acid derivative is still more preferable.

The photo-aligned group is preferably a photo-aligned group described in paragraphs to of WO2020/179864A.

In addition, examples of the repeating unit A represented by Formula (A) include repeating units described in paragraphs to of WO2020/179864A.

A content of the repeating unit including a photo-aligned group in the photo-alignment polymer is not particularly limited, but is preferably 3% to 40% by mole, more preferably 6% to 30% by mole, and still more preferably 10% to 25% by mole with respect to all repeating units of the photo-alignment polymer.

As the repeating unit including a cleavage group in the cleavage group-containing photo-alignment polymer, a repeating unit having, in a side chain, a cleavage group which decomposes by action of at least one selected from the group consisting of light, heat, acid, and base to generate a polar group and having a fluorine atom or a silicon atom at a terminal rather than the cleavage group in a side chain is preferable.

Examples of the cleavage group include a cleavage group (bond) represented by any one of Formulae (rk-1) to (rk-13).

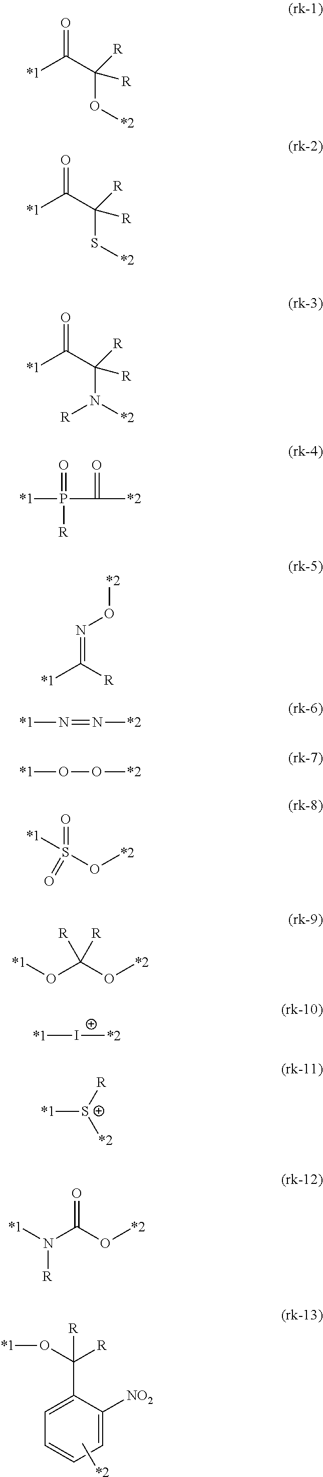

In Formulae (rk-1) to (rk-13), *1 and *2 each independently represent a bonding position, and R's each independently represent a hydrogen atom or a monovalent organic group.

Here, examples of the monovalent organic group represented by R include a chain or cyclic alkyl group having 1 to 20 carbon atoms and an aryl group having 6 to 20 carbon atoms, which may have a substituent.

In addition, an anionic moiety in Formulae (rk-10) and (rk-11) is not particularly limited since it does not affect the cleavage, and either inorganic or organic anions can be used.

Specific examples of the inorganic anion include halide ions such as a chloride ion and a bromide ion, and sulfonate anions.

Specific examples of the organic anion include carboxylate anions such as acetate anions, and organic sulfonate anions such as methanesulfonate anions and paratoluenesulfonate anions.

Examples of such a repeating unit include repeating units described in paragraphs and of WO2018/216812A.

In addition, a repeating unit including a cleavage group which generates a polar group by the action of acid is preferable as such a repeating unit, and suitable specific examples thereof are as follows.

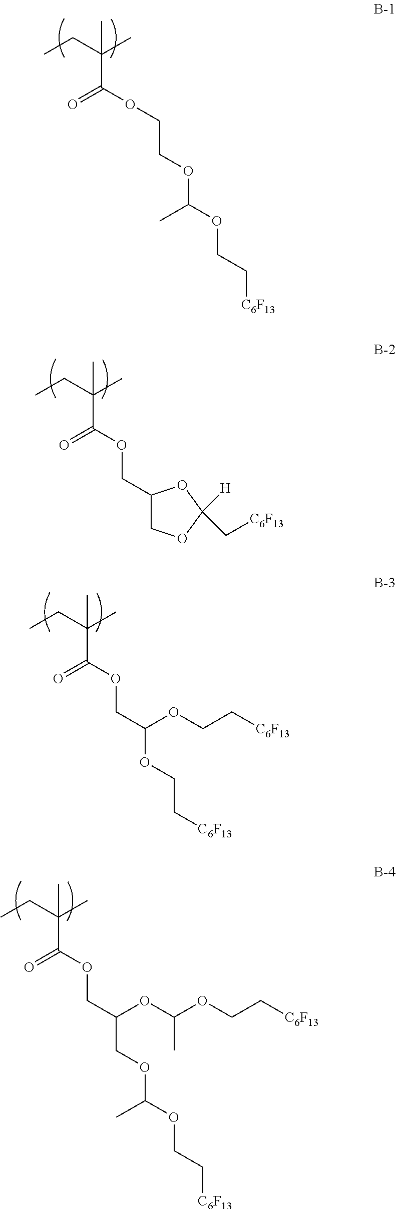

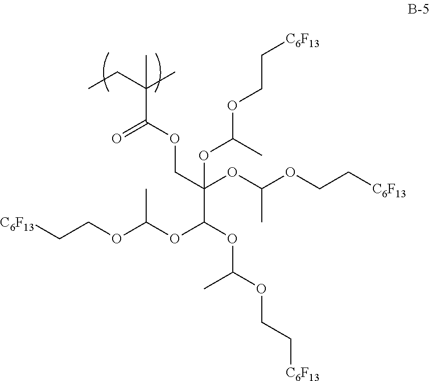

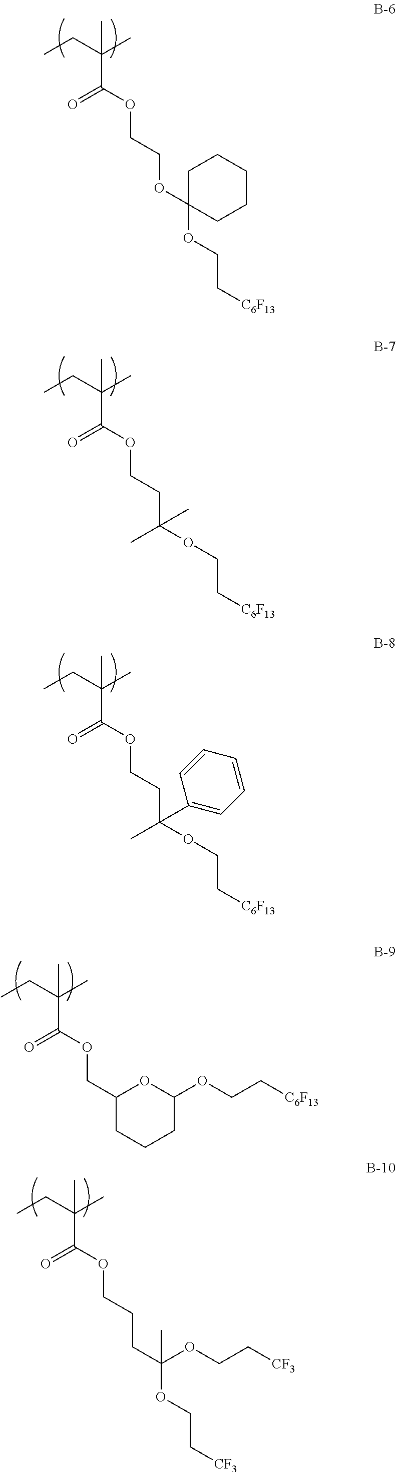

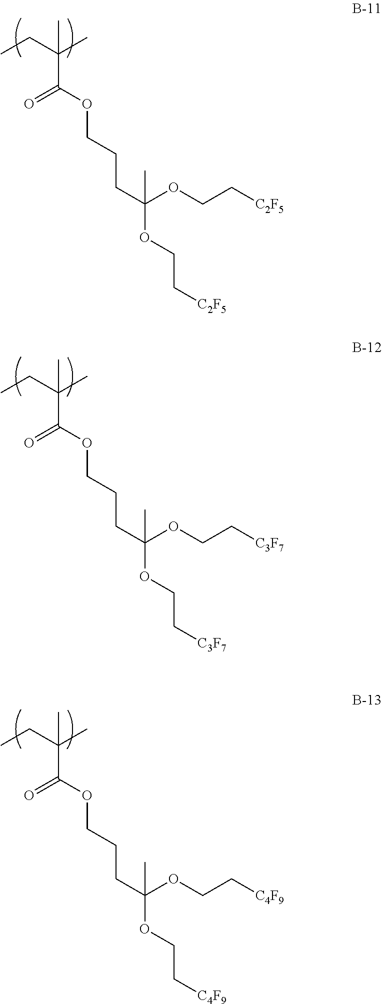

A content of the repeating unit including a cleavage group in the photo-alignment polymer is not particularly limited; but with respect to all repeating units of the photo-alignment polymer, it is preferably 5% by mole or more, more preferably 10% by mole or more, and still more preferably 15% by mole or more, and is more preferably 70% by mole or less, still more preferably 50% by mole or less, and particularly preferably 40% by mole or less.

The photo-alignment polymer may have a repeating unit other than the above-described repeating units.

Examples of a monomer (radically polymerizable monomer) forming other repeating units include an acrylic acid ester compound, a methacrylic acid ester compound, a maleimide compound, an acrylamide compound, acrylonitrile, maleic acid anhydride, a styrene compound, and a vinyl compound.

A method of synthesizing the photo-alignment polymer is not particularly limited, and for example, the photo-alignment polymer can be synthesized by mixing a monomer forming the above-described repeating unit including a photo-aligned group, a monomer forming the above-described repeating unit including a cleavage group, and monomers forming other optional repeating units, and the polymerizing the monomers using a radical polymerization initiator in an organic solvent.

A weight-average molecular weight (Mw) of the photo-alignment polymer is not particularly limited, but is preferably 10,000 to 500,000, more preferably 10,000 to 300,000, and still more preferably 30,000 to 150,000.

Here, the weight-average molecular weight in the present invention is a value measured by gel permeation chromatography (GPC) under the following conditions.
Solvent (eluant): tetrahydrofuran (THF)
Device Name: TOSOH HLC-8320GPC
Column: Three items of TOSOH TSKgel Super HZM-H (4.6 mm×15 cm) are connected and used.
Column Temperature: 40° C.
Sample Concentration: 0.1% by mass
Flow Rate: 1.0 ml/min.
Calibration curve: TSK standard polystyrene (manufactured by TOSOH Corporation), calibration curves of 7 samples with Mw of 2,800,000 to 1,050 (Mw/Mn=1.03 to 1.06) are used

A content of the photo-alignment polymer in the composition for forming the first liquid crystal layer is preferably 0.1% to 20% by mass and more preferably 0.5% to 10% by mass with respect to the content of the liquid crystal compound.

### [Photoacid Generator]

The composition for forming the first liquid crystal layer contains a photoacid generator.

The photo-acid generator is not particularly limited, and is preferably a compound which is sensitive to actinic rays having a wavelength of 300 nm or more, preferably 300 to 450 nm, and generates an acid. A photo-acid generator which is not directly sensitive to actinic rays having a wavelength of 300 nm or more can also be preferably used in combination with a sensitizer as long as it is a compound which is sensitive to actinic rays having a wavelength of 300 nm or more and generates an acid by being used in combination with the sensitizer.

The photo-acid generator is preferably a photo-acid generator which generates an acid with a pKa of 4 or less, more preferably a photo-acid generator which generates an acid with a pKa of 3 or less, and even more preferably a photo-acid generator which generates an acid with a pKa of 2 or less. In the present invention, the pKa basically refers to a pKa in water at 25° C. With a compound which cannot be measured in water, the pKa refers to a pKa measured after changing to a solvent suitable for the measurement. Specifically, the pKa described in a chemical handbook or the like can be referred to. The acid with a pKa of 3 or less is preferably a sulfonic acid or a phosphonic acid, and more preferably a sulfonic acid.

Examples of the photo-acid generator include an onium salt compound, trichloromethyl-s-triazines, a sulfonium salt, an iodonium salt, quaternary ammonium salts, a diazomethane compound, an imidosulfonate compound, and an oxime sulfonate compound. Among these, an onium salt compound, an imidosulfonate compound, or an oxime sulfonate compound is preferable, and an onium salt compound or an oxime sulfonate compound is particularly preferable. The photo-acid generators can be used alone or in combination of two or more types thereof.

A content of the photoacid generator in the composition for forming the first liquid crystal layer is preferably 0.1% to 20% by mass and more preferably 0.5% to 10% by mass with respect to the content of the liquid crystal compound.

### [Polymerization Initiator]

The composition for forming the first liquid crystal layer preferably contains a polymerization initiator.

The polymerization initiator is not particularly limited, and examples thereof include a thermal polymerization initiator and a photopolymerization initiator depending on the method of a polymerization reaction.

The polymerization initiator is preferably a photopolymerization initiator capable of initiating a polymerization reaction by ultraviolet irradiation.

A content of the photopolymerization initiator in the composition for forming the first liquid crystal layer is preferably 0.1% to 20% by mass and more preferably 0.5% to 10% by mass with respect to the content of the liquid crystal compound.

### [Chiral Agent]

The composition for forming the first liquid crystal layer may contain a chiral agent. In a case where the composition for forming the first liquid crystal layer contains a chiral agent, the first liquid crystal layer is a cholesteric liquid crystal layer.

The chiral agent has a function of inducing the helical structure of the cholesteric liquid crystalline phase. The chiral agent may be selected according to the purpose because a helical twisted direction or a helical pitch of the induced helix varies depending on the compound.

The chiral agent is not particularly limited, and a known compound (for example, described in “Liquid Crystal Device Handbook”, Chapter 3, Section 4-3, chiral agent for twisted nematic (TN) and super twisted nematic (STN), p. 199, Japan Society for the Promotion of Science edited by the 142nd committee, 1989), a derivative of isosorbide, isomannide, and the like can be used.

The chiral agent generally includes an asymmetric carbon atom, but an axially asymmetric compound or a planar asymmetric compound, including no asymmetric carbon atom, can also be used as the chiral agent. Examples of the axially asymmetric compound or the planar asymmetric compound include binaphthyl, helicene, paracyclophane, and derivatives thereof. The chiral agent may also have a polymerizable group. In a case where both the chiral agent and the liquid crystal compound have a polymerizable group, a polymer having a repeating unit induced from the polymerizable liquid crystal compound and a repeating unit induced from the chiral agent can be formed by a polymerization reaction between the polymerizable chiral agent and the polymerizable liquid crystal compound.

A content of the chiral agent in the composition for forming the first liquid crystal layer is preferably 0.01% to 200% by mole and more preferably 1% to 30% by mole with respect to the contained molar amount of the liquid crystal compound.

### [Solvent]

From the viewpoint of workability, the composition for forming the first liquid crystal layer preferably contains a solvent.

Examples of the solvent include ketones, ethers, aliphatic hydrocarbons, alicyclic hydrocarbons, aromatic hydrocarbons, carbon halides, esters, water, alcohols, cellosolves, cellosolve acetates, sulfoxides, and amides.

The solvent may be used alone or in combination of two or more kinds thereof.

A method of forming the coating film of the composition for forming the first liquid crystal layer is not particularly limited, and examples thereof include a method of applying the composition for forming the first liquid crystal layer onto a support and optionally performing a drying treatment.

Examples of the support include the above-described supports.

In addition, an alignment film may be disposed on the support. Examples of the alignment film include the above-described alignment films.

A method of applying the composition for forming the first liquid crystal layer is not particularly limited, and examples thereof include a spin coating method, an air knife coating method, a curtain coating method, a roller coating method, a wire bar coating method, a gravure coating method, and a die coating method.

### (Step 2)

The step 2 is a step of aligning the liquid crystal compound in the coating film obtained in the step 1, and performing a curing treatment and an acid generation treatment to form the first liquid crystal layer. The cleavage group-containing photo-alignment polymer is likely to be unevenly distributed on the air-side surface of the coating film. In particular, in a case where the cleavage group-containing photo-alignment polymer has a fluorine atom or a silicon atom, the above-described uneven distribution is likely to occur.

A method of aligning the liquid crystal compound in the coating film is not particularly limited, and examples thereof include a method of heating the coating film.

Examples of the curing treatment include a light irradiation treatment and a heating treatment.

The conditions of the curing treatment are not particularly limited, and ultraviolet rays are preferably used in polymerization by light irradiation. An irradiation amount is preferably 10 mJ/cm² to 50 J/cm² and more preferably 20 mJ/cm² to 5 J/cm². In order to promote the polymerization reaction, the treatment may be performed under heating conditions.

The treatment for generating an acid from the photo-acid generator in the coating film is a treatment for generating an acid by irradiation with light to which the photo-acid generator is exposed. By performing the treatment, cleavage at the cleavage group proceeds, and the group containing a fluorine atom or a silicon atom is eliminated.

The light irradiation treatment performed in the above-described treatment may be a treatment in which the photo-acid generator is exposed to light, and examples thereof include an ultraviolet irradiation method. As a light source, a lamp emitting ultraviolet rays, such as a high-pressure mercury lamp and a metal halide lamp, can be used. In addition, an irradiation amount is preferably 10 mJ/cm² to 50 J/cm² and more preferably 20 mJ/cm² to 5 J/cm².

Regarding the curing treatment and the acid generation treatment described above, the acid generation treatment may be performed after the curing treatment, or the curing treatment and the acid generation treatment may be performed simultaneously. In particular, in a case where the photo-acid generator and the polymerization initiator are exposed to light having the same wavelength, the curing treatment and the acid generation treatment are performed simultaneously, which is preferable from the viewpoint of productivity.

### (Step 3)

The step 3 is a step of subjecting the first liquid crystal layer obtained in the step 2 to a photo-alignment treatment. By performing the present step, an alignment restriction force can be imparted to the surface of the first liquid crystal layer. By the photo-alignment treatment, the first liquid crystal layer having an alignment restriction force, capable of forming the above-described liquid crystal alignment pattern, can be formed. In addition, by adjusting treatment conditions of the photo-alignment treatment, an alignment restriction force capable of forming various alignment patterns can be imparted.

Examples of the photo-alignment treatment include a method of irradiating the first liquid crystal layer with polarized light or irradiating the first liquid crystal layer with non-polarized light in an oblique direction with respect to the surface of the coating film.

In the photo-alignment treatment, the polarized light to be irradiated is not particularly limited; and examples thereof include linearly polarized light, circularly polarized light, and elliptically polarized light, and linearly polarized light is preferable.

In addition, the “oblique direction” in which irradiation with unpolarized light is performed is not particularly limited as long as it is a direction inclined at a polar angle θ (0°<0<90°) with respect to a normal direction of the surface of the coating film. θ can be appropriately selected according to the purpose, and is preferably 20° to 80°.

A wavelength of the polarized light or the unpolarized light is not particularly limited as long as the light is light to which the photo-aligned group is exposed. Examples thereof include ultraviolet rays, near-ultraviolet rays, and visible rays, and near-ultraviolet rays of 250 to 450 nm are preferable.

In addition, examples of a light source for the irradiation with polarized light or unpolarized light include a xenon lamp, a high-pressure mercury lamp, an ultra-high pressure mercury lamp, and a metal halide lamp. By using an interference filter, a color filter, or the like with respect to ultraviolet rays or visible rays obtained from the light source, the wavelength range of the irradiation can be restricted. In addition, linearly polarized light can be obtained by using a polarization filter or a polarization prism with respect to the light from the light source.

An integrated quantity of the polarized light or the unpolarized light is not particularly limited, and is preferably 1 to 500 mJ/cm² and more preferably 5 to 400 mJ/cm².

An illuminance of the polarized light or the unpolarized light is not particularly limited, and is preferably 0.1 to 500 mW/cm² and more preferably 1 to 300 mW/cm².

### (Step 4)

The step 4 is a step of applying a composition for forming the second liquid crystal layer, containing a liquid crystal compound, onto the first liquid crystal layer obtained in the step 3 to form the second liquid crystal layer. By performing the present step, an optical laminate including the first liquid crystal layer and the second liquid crystal layer, which are disposed adjacent to each other, is obtained.

Examples of the liquid crystal compound contained in the composition for forming the second liquid crystal layer include the liquid crystal compound contained in the composition for forming the first liquid crystal layer.

Examples of components contained in the composition for forming the second liquid crystal layer, other than the liquid crystal compound, include the components contained in the composition for forming the first liquid crystal layer.

Examples of a method of applying the composition for forming the second liquid crystal layer include the method of applying the composition for forming the first liquid crystal layer.

Examples of a method of forming the second liquid crystal layer from the coating film obtained by applying the composition for forming the second liquid crystal layer include the method of forming the first liquid crystal layer.

### <Applications>

The optical laminate according to the embodiment of the present invention can be applied to various applications. Examples thereof include a display device, a sensor, and a light polarizer.

Examples of the display device include an augmented reality display device and a virtual reality display device.

In addition, the optical laminate according to the embodiment of the present invention may be used in combination with other members.

Examples of the other members include a polarizer.

For example, a polarizer may be disposed on the surface of the second liquid crystal layer 14D in the optical laminate 10E shown in FIG. 16, opposite to the first liquid crystal layer 12C side. In a case where circularly polarized light is emitted from the first liquid crystal layer 12C side of the obtained laminate, the circularly polarized light is emitted in a predetermined direction tilted by the first liquid crystal layer 12C, the emitted circularly polarized light is converted into linearly polarized light by the second liquid crystal layer 14D, and the converted linearly polarized light can pass through the polarizer. In such a laminate, light can be diffracted with high diffraction efficiency and light which is not diffracted by the polarizer can be absorbed, so that reduction of leaked light can also be achieved.

### EXAMPLES

Hereinafter, the present invention will be described in more detail with reference to Examples. The materials, the amounts of materials used, the proportions, the treatment details, and the treatment procedure in Examples below may be appropriately modified as long as the modifications do not depart from the spirit of the present invention. Therefore, the scope of the present invention should not be construed as being limited to Examples shown below.

### Example 1

### (Formation of Alignment Film)

The following coating liquid for forming an alignment film was continuously applied onto a support using a #2 wire bar. The support on which the coating film of the alignment film-forming coating liquid was formed was dried using a hot plate at 60° C. for 60 seconds. As a result, an alignment film was formed.

-Alignment film-forming coating liquid-

| | | |
|---|---|---|
| Material A for photo-alignment | 1.00 | part by mass |
| Water | 16.00 | parts by mass |
| Butoxyethanol | 42.00 | parts by mass |
| Propylene glycol monomethyl ether | 42.00 | parts by mass |

### Material a for Photo-Alignment (See Structural Formula Below)

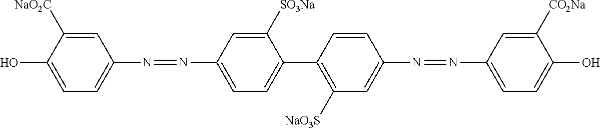

The alignment film was exposed using the exposure device shown in FIG. 18 to form a patterned alignment film P-1 having an alignment pattern.

In the exposure device, a laser which emits laser beam having a wavelength (325 nm) was used as the laser. An exposure amount of the interference light was set to 300 mJ/cm². A single period Λ of an alignment pattern formed by interference of two laser beams was controlled by changing an intersecting angle (intersecting angle α) between the two beams. The single period Λ was 2.0 μm.

### (Formation of First Liquid Crystal Layer A)

The following polymerizable liquid crystal compound A (80 parts by mass), the following polymerizable liquid crystal compound B (20 parts by mass), a photopolymerization initiator (IRGACURE 907, manufactured by BASF) (3 parts by mass), a sensitizer (KAYACURE DETX, manufactured by Nippon Kayaku Co., Ltd.) (1 part by mass), the following horizontal alignment agent (0.3 parts by mass), the following photoacid generator (B-1-1) (3.0 parts by mass), the following chiral agent (Ch-1) (5.46 parts by mass), and the following cleavage group-containing photo-alignment polymer FP-1 (2 parts by mass) were dissolved in cyclopentanone (193 parts by mass) to prepare a composition X for forming a first liquid crystal layer.

The above-described composition X for forming a first liquid crystal layer was applied onto the above-described alignment film using a #7 wire bar coater, heated at 60° C. for 2 minutes, and irradiated with ultraviolet rays at an irradiation amount of 100 mJ/cm² using a UV-LED (wavelength: 365 nm) while purging with nitrogen in an atmosphere with an oxygen concentration of 1.0% by volume or less and maintaining the temperature at 60° C. Furthermore, the obtained coating film was exposed to the interference light by the exposure device shown in FIG. 18 after being heated at 130° C. for 1 minute, thereby forming a first liquid crystal layer A having a photo-alignment function.

In the exposure device, a laser which emits laser beam having a wavelength (325 nm) was used as the laser. An exposure amount of the interference light was set to 300 mJ/cm². A single period Λ of an alignment pattern formed by interference of two laser beams was controlled by changing an intersecting angle (intersecting angle α) between the two beams. In addition, a rotation direction of the optical axes was adjusted by rotating the optical axes of the λ/4 plates 72A and 72B in the exposure device by 90°, respectively.

A film thickness of the first liquid crystal layer A was 3.0 μm. In addition, the single period Λ was 2.0 μm.

### Polymerizable Liquid Crystal Compound A

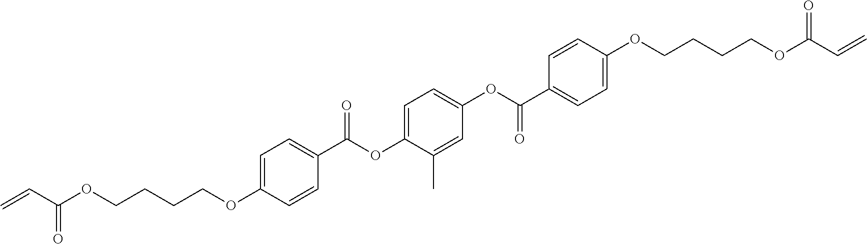 [SMILES: C=CC(=O)OCCCCOc1ccc(C(=O)Oc2ccc(OC(=O)c3ccc(OCCCCOC(=O)C=C)cc3)c(C)c2)cc1]

### Polymerizable Liquid Crystal Compound B

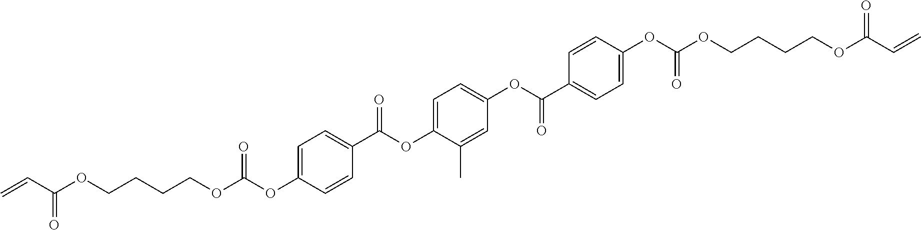 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

Horizontal alignment agent (in the formula, the numerical value described in each repeating unit denotes the content (% by mass) of each repetition with respect to all repeating units)

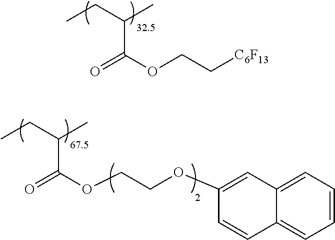

### Photoacid Generator (B-1-1)

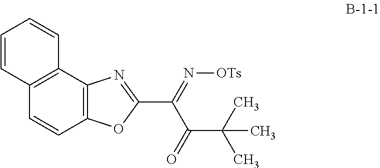 [SMILES: Cc1ccc(S(=O)(=O)O/N=C(\C(=O)C(C)(C)C)c2nc3c(ccc4ccccc43)o2)cc1]

### Cleavage Group-Containing Photo-Alignment Polymer (FP-1)

(the numerical value described in each repeating unit denotes the content (% by mole) of each repeating unit with respect to all repeating units)

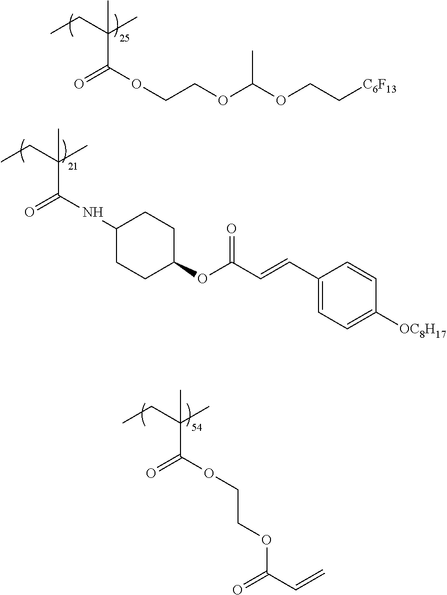

### Chiral Agent (Ch-1)

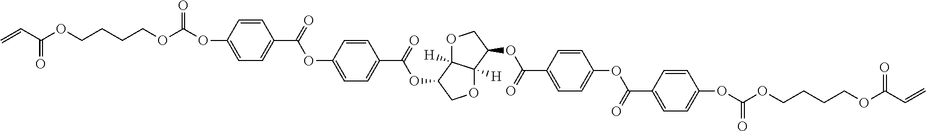 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

### Leveling Agent T-1

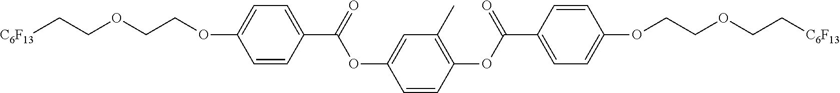

### (Formation of Second Liquid Crystal Layer A)

Next, a composition X for forming a second liquid crystal layer, containing a rod-like liquid crystal compound having the following composition, was applied onto the first liquid crystal layer A produced above using a slot die coater, and heated with hot air at 80° C. for 60 seconds. Subsequently, the obtained composition layer was irradiated with UV (500 mJ/cm²) at 80° C. to fix the alignment of the liquid crystal compound to form a second liquid crystal layer A, thereby obtaining an optical laminate 1 including the first liquid crystal layer A and the second liquid crystal layer A.

A thickness of the second liquid crystal layer A was 3.0 μm.

The composition X for forming a second liquid crystal layer was a liquid crystal composition forming a cholesteric liquid crystal layer (cholesteric liquid crystalline phase) which had a selective reflection central wavelength of 550 nm and reflected dextrorotatory circularly polarized light.

The first liquid crystal layer A and the second liquid crystal layer A were adjacent to each other.

Both the first liquid crystal layer A and the second liquid crystal layer A had the above-described liquid crystal alignment pattern, and the rotation direction of the optical axis derived from the liquid crystal compound in the liquid crystal alignment pattern of the first liquid crystal layer A and the rotation direction of the optical axis derived from the liquid crystal compound in the liquid crystal alignment pattern of the second liquid crystal layer A were opposite to each other (refer to FIG. 1).

-Composition X for forming second liquid crystal layer-

| | |
|---|---|
| Rod-like liquid crystal compound L-1 | 100.00 parts by mass |
| Polymerization initiator (IRGACURE (registered trade name) 907, manufactured by BASF SE) | 3.00 parts by mass |
| Photosensitizer (KAYACURE DETX-S manufactured by Nippon Kayaku Co., Ltd.) | 1.00 part by mass |
| Chiral agent Ch-2 | 5.46 parts by mass |
| Leveling agent T-1 | 0.08 parts by mass |
| Methyl ethyl ketone | 268.20 parts by mass |

Rod-like liquid crystal compound L-1 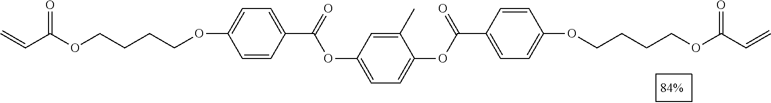 [SMILES: C=CC(=O)OCCCCOc1ccc(C(=O)Oc2ccc(OC(=O)c3ccc(OCCCCOC(=O)C=C)cc3)c(C)c2)cc1] 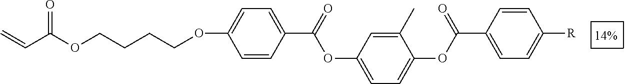 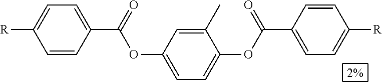 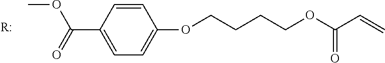
Chiral agent Ch-2

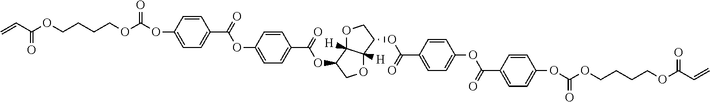 [SMILES: C=CC(=O)OCCCCOC(=O)Oc1ccc(C(=O)Oc2ccc(C(=O)O[C@H]3CO[C@@H]4[C@H]3OC[C@H]4OC(=O)c3ccc(OC(=O)c4ccc(OC(=O)OCCCCOC(=O)C=C)cc4)cc3)cc2)cc1]

### Example 2

An optical laminate 2 was obtained according to the same procedure as in Example 1, except that the conditions of the intersecting angle between two beams in a case where the liquid crystal layer of (Formation of the first liquid crystal layer A) in Example 1 was exposed to the interference light were changed and the addition amount of the chiral agent used in the composition X for forming a second liquid crystal layer was changed.

The optical laminate 2 included a first liquid crystal layer A formed of the composition X for forming a first liquid crystal layer and a second liquid crystal layer B formed of the composition X for forming a second liquid crystal layer.

The first liquid crystal layer A and the second liquid crystal layer B were adjacent to each other.

Both the first liquid crystal layer A and the second liquid crystal layer B had the above-described liquid crystal alignment pattern, and the rotation direction of the liquid crystal alignment pattern of the first liquid crystal layer A and the rotation direction of the liquid crystal alignment pattern of the second liquid crystal layer B were the same. In addition, in the liquid crystal alignment pattern of the first liquid crystal layer A, the length over which the orientation of the optical axis derived from the liquid crystal compound rotated by 180° in a plane was 1.3 μm; and in the liquid crystal alignment pattern of the second liquid crystal layer B, the length over which the direction of the optical axis derived from the liquid crystal compound rotated by 180° in a plane was 1.5 μm, which were different from each other. In addition, the helical pitch of the helical structure of the first liquid crystal layer A was 0.28 μm, and the helical pitch of the helical structure of the second liquid crystal layer B was 0.33 μm (refer to FIG. 6).

### Example 3

An optical laminate 3 was obtained according to the same procedure as in Example 1, except that the treatment of exposing the liquid crystal layer to the interference light of (Formation of the first liquid crystal layer A) in Example 1 was changed to a treatment of exposing the liquid crystal layer to linearly polarized light, and a composition Y for forming a second liquid crystal layer was used instead of the composition X for forming a second liquid crystal layer used in (Formation of second liquid crystal layer A).

The optical laminate 3 included a first liquid crystal layer A formed of the composition X for forming a first liquid crystal layer and a second liquid crystal layer C formed of the composition Y for forming a second liquid crystal layer.

The first liquid crystal layer A and the second liquid crystal layer C were adjacent to each other.

The first liquid crystal layer A had the above-described liquid crystal alignment pattern, and the second liquid crystal layer C contained a liquid crystal compound homogeneously aligned (refer to FIG. 14).

-Composition Y for forming second liquid crystal layer-

| Rod-like liquid crystal compound L-1 | 100.00 | parts by mass |
|---|---|---|
| Polymerization initiator (IRGACURE | 3.00 | parts by mass |
| (registered trade name) 907, | | |
| manufactured by BASF SE) | | |
| Photosensitizer (KAYACURE DETX-S | 1.00 | part by mass |
| manufactured by Nippon Kayaku Co., Ltd.) | | |
| Leveling agent T-1 | 0.08 | parts by mass |
| Methyl ethyl ketone | 268.20 | parts by mass |

### Example 4

An optical laminate 4 was obtained according to the same procedure as in Example 1, except that a composition Y for forming a first liquid crystal layer was used instead of the composition X for forming a first liquid crystal layer used in (Formation of first liquid crystal layer A), and the composition Y for forming a second liquid crystal layer was used instead of the composition X for forming a second liquid crystal layer used in (Formation of second liquid crystal layer A).

The optical laminate 4 included a first liquid crystal layer B formed of the composition Y for forming a first liquid crystal layer and a second liquid crystal layer D formed of the composition Y for forming a second liquid crystal layer.

The first liquid crystal layer B and the second liquid crystal layer D were adjacent to each other.

Both the first liquid crystal layer B and the second liquid crystal layer D had the above-described liquid crystal alignment pattern, and the rotation direction of the optical axis derived from the liquid crystal compound in the liquid crystal alignment pattern of the first liquid crystal layer B and the rotation direction of the optical axis derived from the liquid crystal compound in the liquid crystal alignment pattern of the second liquid crystal layer D were opposite to each other (refer to FIG. 8).

-Composition Y for forming first liquid crystal layer-

| Polymerizable liquid crystal compound A | 80 | parts by mass |
|---|---|---|
| Polymerizable liquid crystal compound B | 20 | parts by mass |
| Photopolymerization initiator | 3 | parts by mass |
| (IRGACURE 907, manufactured by BASF) | | |
| Sensitizer (KAYACURE DETX, manufactured | 1 | part by mass |
| by Nippon Kayaku Co., Ltd.) | | |
| Horizontal alignment agent shown above | 0.3 | parts by mass |
| Photoacid generator (B-1-1) | 3.0 | parts by mass |
| Cleavage group-containing photo- | 2 | parts by mass |
| alignment polymer FP-1 | | |
| Cyclopentanone | 193 | parts by mass |

### Example 5

An optical laminate 5 was obtained according to the same procedure as in Example 4, except that the treatment of exposing the liquid crystal layer to the interference light of (Formation of the first liquid crystal layer A) in Example 4 was changed to a treatment of exposing the liquid crystal layer to linearly polarized light.

The optical laminate 5 included a first liquid crystal layer B formed of the composition Y for forming a first liquid crystal layer and a second liquid crystal layer E formed of the composition Y for forming a second liquid crystal layer.

The first liquid crystal layer B and the second liquid crystal layer E were adjacent to each other.

The first liquid crystal layer B had the above-described liquid crystal alignment pattern, and the second liquid crystal layer E contained a liquid crystal compound homogeneously aligned (refer to FIG. 16).

### Comparative Example 1

An alignment film was produced according to the same procedure as in (Formation of alignment film) of Example 1.

The above-described composition X for forming a first liquid crystal layer was applied onto the above-described alignment film using a #7 wire bar coater, heated at 60° C. for 2 minutes, and irradiated with ultraviolet rays at an irradiation amount of 100 mJ/cm² using a UV-LED (wavelength: 365 nm) while purging with nitrogen in an atmosphere with an oxygen concentration of 1.0% by volume or less and maintaining the temperature at 60° C., thereby forming a liquid crystal layer C1.

In addition, an alignment film was produced according to the same procedure as in (Formation of alignment film) of Example 1.

The above-described composition X for forming a second liquid crystal layer was applied onto the above-described alignment film using a #7 wire bar coater, heated at 60° C. for 2 minutes, and irradiated with ultraviolet rays at an irradiation amount of 100 mJ/cm² using a UV-LED (wavelength: 365 nm) while purging with nitrogen in an atmosphere with an oxygen concentration of 1.0% by volume or less and maintaining the temperature at 60° C., thereby forming an alignment film C2.

The liquid crystal layer C1 and the liquid crystal layer C2 produced by the above-described procedures were allowed to face each other and bonded to each other through a pressure-sensitive adhesive to obtain an optical laminate C1.

In the optical laminate C1, the rotation direction of the optical axis derived from the liquid crystal compound in the liquid crystal alignment pattern of the liquid crystal layer C1 and the rotation direction of the optical axis derived from the liquid crystal compound in the liquid crystal alignment pattern of the liquid crystal layer C2 were opposite to each other.

### Comparative Example 2

A liquid crystal layer C1 was formed according to the same procedure as in Comparative Example 1.

A liquid crystal layer C3 was formed according to the same procedure as the procedure for the production of the liquid crystal layer C1 described above, except that the conditions for the intersecting angle between two beams in a case where the alignment film was exposed to the interference light in (Formation of alignment film) in Example 1 were changed, the optical axes of the λ/4 plates 72A and 72B in the exposure device were respectively rotated by 90° to adjust the rotation direction of the optical axis, and the addition amount of the chiral agent used in the composition X for forming a second liquid crystal layer was changed.

The liquid crystal layer C1 and the liquid crystal layer C3 produced by the above-described procedures were allowed to face each other and bonded to each other through a pressure-sensitive adhesive to obtain an optical laminate C2.

Both the liquid crystal layer C1 and the liquid crystal layer C3 had the above-described liquid crystal alignment pattern, and the rotation direction of the optical axis derived from the liquid crystal compound in the liquid crystal alignment pattern of the liquid crystal layer C1 and the rotation direction of the optical axis derived from the liquid crystal compound in the liquid crystal alignment pattern of the liquid crystal layer C2 were the same. In addition, in the liquid crystal alignment pattern of the liquid crystal layer C1, the length over which the orientation of the optical axis derived from the liquid crystal compound rotated by 180° in a plane was 1.3 μm; and in the liquid crystal alignment pattern of the liquid crystal layer C3, the length over which the direction of the optical axis derived from the liquid crystal compound rotated by 180° in a plane was 1.5 μm, which were different from each other.

### Comparative Example 3

A liquid crystal layer C1 was formed according to the same procedure as in Comparative Example 1.

An alignment film was produced according to the same procedure as in (Formation of alignment film) of Example 1, except that, in the method of (Formation of alignment film) of Example 1, the treatment of exposing the alignment film to the interference light was changed to a treatment of exposing the alignment film to linearly polarized light.

The above-described composition Y for forming a second liquid crystal layer was applied onto the above-described alignment film using a #7 wire bar coater, heated at 60° C. for 2 minutes, and irradiated with ultraviolet rays at an irradiation amount of 100 mJ/cm² using a UV-LED (wavelength: 365 nm) while purging with nitrogen in an atmosphere with an oxygen concentration of 1.0% by volume or less and maintaining the temperature at 60° C., thereby forming an alignment film C4.

The liquid crystal layer C1 and the liquid crystal layer C4 produced by the above-described procedures were allowed to face each other and bonded to each other through a pressure-sensitive adhesive to obtain an optical laminate C3.

### Comparative Example 4

An alignment film was produced according to the same procedure as in (Formation of alignment film) of Example 1.

The above-described composition Y for forming a first liquid crystal layer was applied onto the above-described alignment film using a #7 wire bar coater, heated at 60° C. for 2 minutes, and irradiated with ultraviolet rays at an irradiation amount of 100 mJ/cm² using a UV-LED (wavelength: 365 nm) while purging with nitrogen in an atmosphere with an oxygen concentration of 1.0% by volume or less and maintaining the temperature at 60° C., thereby forming an alignment film C5.

In addition, an alignment film was produced according to the same procedure as in (Formation of alignment film) of Example 1.

The above-described composition Y for forming a second liquid crystal layer was applied onto the above-described alignment film using a #7 wire bar coater, heated at 60° C. for 2 minutes, and irradiated with ultraviolet rays at an irradiation amount of 100 mJ/cm² using a UV-LED (wavelength: 365 nm) while purging with nitrogen in an atmosphere with an oxygen concentration of 1.0% by volume or less and maintaining the temperature at 60° C., thereby forming an alignment film C6.

The liquid crystal layer C5 and the liquid crystal layer C6 produced by the above-described procedures were allowed to face each other and bonded to each other through a pressure-sensitive adhesive to obtain an optical laminate C4.

Both the liquid crystal layer C5 and the liquid crystal layer C6 had the above-described liquid crystal alignment pattern, and the rotation direction of the optical axis derived from the liquid crystal compound in the liquid crystal alignment pattern of the liquid crystal layer C5 and the rotation direction of the optical axis derived from the liquid crystal compound in the liquid crystal alignment pattern of the liquid crystal layer C6 were opposite to each other.

### Comparative Example 5

A liquid crystal layer C5 was formed according to the same procedure as in Comparative Example 4.

A liquid crystal layer C4 was formed according to the same procedure as in Comparative Example 3.

The liquid crystal layer C5 and the liquid crystal layer C4 produced by the above-described procedures were allowed to face each other and bonded to each other through a pressure-sensitive adhesive to obtain an optical laminate C5.

### Evaluation

### (Multiple Reflection)

A reflectivity of a specular reflection component (component in which angles of incident light and reflected light with respect to the normal line were the same) in a case where light was incident into the optical laminate produced in each of Examples and Comparative Examples was measured and evaluated according to the following standard. In the measurement, laser light having output central wavelengths of a wavelength of 450 nm, a wavelength of 532 nm, and a wavelength of 650 nm was emitted from a light source.
A: all three reflectivities measured by irradiation with three types of laser light (wavelength of 450 nm, wavelength of 532 nm, and wavelength of 650 nm) were 0.5% or less.
B: at least one of the three reflectivities was more than 0.5%.

### (Diffraction Angle Evaluation 1)

In a case where dextrorotatory circularly polarized light and levorotatory circularly polarized light were respectively incident on the predetermined optical laminate produced above (optical laminates of Examples 1 to 3 and Comparative Examples 1 to 3) from the front (direction with an angle of 0° with respect to the normal line), the diffraction angle of emitted light was evaluated according to the following standard. In the emitted light, the angle of diffracted light (first-order ray) diffracted by the optical laminate was measured.

In the measurement, laser light (dextrorotatory circularly polarized light and levorotatory circularly polarized light) having output central wavelengths of a wavelength of 450 nm, a wavelength of 532 nm, and a wavelength of 650 nm was emitted from a light source.
A: in any of the measurement results of the three types of laser light (wavelength of 450 nm, wavelength of 532 nm, and wavelength of 650 nm), a difference between the diffraction angle in a case where the dextrorotatory circularly polarized light was incident and the diffraction angle in a case where the levorotatory circularly polarized light was incident was 1.0° or less.
B: in at least one of the measurement results of the three types of laser light (wavelength of 450 nm, wavelength of 532 nm, and wavelength of 650 nm), a difference between the diffraction angle in a case where the dextrorotatory circularly polarized light was incident and the diffraction angle in a case where the levorotatory circularly polarized light was incident was more than 1.0°.

### (Diffraction Angle Evaluation 2)

In a case where light was incident on the predetermined optical laminate produced above (optical laminates of Example 4 and Comparative Example 4) from the front (direction with an angle of 0° with respect to the normal line), the diffraction angle of emitted light was evaluated according to the following standard. In the emitted light, the diffraction angle of diffracted light (first-order ray) diffracted by the optical laminate was measured.

In the measurement, laser light having output central wavelengths of a wavelength of 450 nm, a wavelength of 532 nm, and a wavelength of 650 nm was emitted from a light source.
A: in any of the measurement results of the three types of laser light (wavelength of 450 nm, wavelength of 532 nm, and wavelength of 650 nm), the diffraction angle of the diffracted light was larger than the diffraction angle calculated from the length over which the orientation of the optical axis derived from the liquid crystal compound rotated by 180° in a plane and the wavelength of the incidence ray by 2° or more.
B: in at least one of the measurement results of the three types of laser light (wavelength of 450 nm, wavelength of 532 nm, and wavelength of 650 nm), the diffraction angle of diffracted light was the same as or larger than the diffraction angle of diffracted light calculated from the length over which the orientation of the optical axis derived from the liquid crystal compound rotated by 180° in a plane and the wavelength of the incidence ray, but the difference therebetween was less than 2°.

### (Diffraction Efficiency Evaluation)

In a case where light was incident on the predetermined optical laminate produced above (optical laminates of Example 5 and Comparative Example 5) from the front (direction with an angle of 0° with respect to the normal line), the diffraction efficiency of emitted light was evaluated according to the following standard.

In the measurement, laser light having output central wavelengths of a wavelength of 450 nm, a wavelength of 532 nm, and a wavelength of 650 nm was emitted from a light source.

With regard to the diffraction efficiency, intensities of diffracted light (first-order ray) diffracted in a desired direction, zero-order ray (emitted in the same direction as incidence light) emitted in the other directions, and negative first-order ray (light diffracted in a −θ direction in a case where the diffraction angle of first-order ray with respect to zero-order ray was represented by θ) were measured using a photodetector, the diffraction efficiency at each of the wavelengths was calculated from the following expression, and the average value thereof was obtained as an evaluation value.

$$Diffraction efficiency = First - order ray / ( First - order ray + Zeroth - order ray + ( Negative first - order ray ) )$$

A: in any of the measurement results of the three types of laser light (wavelength of 450 nm, wavelength of 532 nm, and wavelength of 650 nm), the measured diffraction efficiency was higher than the diffraction efficiency of the reference layer by 1% or more.
B: in at least one of measurement results of the three types of laser light (wavelength of 450 nm, wavelength of 532 nm, and wavelength of 650 nm), the measured diffraction efficiency was the same as or higher than the diffraction efficiency of the reference layer, but the difference was less than 1%.

The above-described diffraction efficiency of the reference layer is the diffraction efficiency of the single first liquid crystal layer B in the case of Example 5 and the diffraction efficiency of the single liquid crystal layer C5 in the case of Comparative Example 5.

In the columns of “First liquid crystal layer” and “Second liquid crystal layer” of Table 1, “Reflection” indicates that the first liquid crystal layer or the second liquid crystal layer had the liquid crystal alignment pattern and was a cholesteric liquid crystal layer; “Transmission” indicates that the first liquid crystal layer or the second liquid crystal layer had the liquid crystal alignment pattern and did not have a helical structure in the thickness direction; and “Homogeneous” indicates that the second liquid crystal layer was a layer containing a liquid crystal compound homogeneously aligned.

In the column of “Requirement 1” of Table 1, a case where the requirement 1 was satisfied is indicated by “A”, and a case where the requirement 1 was not satisfied is indicated by “B”.

In the column of “Requirement 2” of Table 1, a case where the requirement 2 was satisfied is indicated by “A”, and a case where the requirement 2 was not satisfied is indicated by “B”.

In the column of “Requirement 3” of Table 1, a case where the requirement 3 was satisfied is indicated by “A”, and a case where the requirement 3 was not satisfied is indicated by “B”

TABLE 1

| | | | | | | Multiple | Diffraction | Diffraction | Diffraction |
|---|---|---|---|---|---|---|---|---|---|
| | First liquid | Second liquid | Requirement | Requirement | Requirement | reflection | angle | angle | efficiency |
| | crystal layer | crystal layer | 1 | 2 | 3 | evaluation | evaluation 1 | evaluation 2 | evaluation |
| Example 1 | Reflection | Reflection | A | B | B | A | A | — | — |
| Comparative | Reflection | Reflection | A | B | B | B | A | — | — |
| Example 1 | | | | | | | | | |
| Example 2 | Reflection | Reflection | B | A | B | A | A | — | — |
| Comparative | Reflection | Reflection | B | A | B | B | A | — | — |
| Example 2 | | | | | | | | | |
| Example 3 | Reflection | Homogeneous | B | B | A | A | A | — | — |
| Comparative | Reflection | Homogeneous | B | B | A | B | A | — | — |
| Example 3 | | | | | | | | | |
| Example 4 | Transmission | Transmission | A | B | B | A | — | A | — |
| Comparative | Transmission | Transmission | A | B | B | B | — | A | — |
| Example 4 | | | | | | | | | |
| Example 5 | Transmission | Homogeneous | B | B | A | A | — | — | A |
| Comparative | Transmission | Homogeneous | B | B | A | B | — | — | A |
| Example 5 | | | | | | | | | |

As shown in the above table, it was found that the optical laminate according to the embodiment of the present invention exhibited a desired effect.

### EXPLANATION OF REFERENCES

10A, 10B, 10C, 10D, 10E: optical laminate
12A, 12B, 12C: first liquid crystal layer
14A, 14B, 14C, 14D: second liquid crystal layer
30: liquid crystal compound
60: exposure device
62: laser
64: light source
65: λ/2 plate
68: polarization beam splitter
70A, 70B: mirror
72A, 72B: λ/4 plate
80: alignment film
82: support

What is claimed is:

1. An optical laminate comprising:
a first liquid crystal layer containing a liquid crystal compound; and
a second liquid crystal layer containing a liquid crystal compound,
wherein the first liquid crystal layer and the second liquid crystal layer are adjacent to each other,
the first liquid crystal layer has a liquid crystal alignment pattern in which an orientation of an optical axis derived from the liquid crystal compound changes while continuously rotating in at least one in-plane direction, and
any one of requirements 1 to 3 is satisfied,
the requirement 1: the second liquid crystal layer has a liquid crystal alignment pattern in which an orientation of an optical axis derived from the liquid crystal compound changes while continuously rotating in at least one in-plane direction, and a rotation direction of the optical axis in the liquid crystal alignment pattern of the first liquid crystal layer is opposite to a rotation direction of the optical axis in the liquid crystal alignment pattern of the second liquid crystal layer,
the requirement 2: the second liquid crystal layer has a liquid crystal alignment pattern in which an orientation of an optical axis derived from the liquid crystal compound changes while continuously rotating in at least one in-plane direction, and a length over which the orientation of the optical axis derived from the liquid crystal compound in the liquid crystal alignment pattern of the first liquid crystal layer rotates by 180° in a plane differs from a length over which the orientation of the optical axis derived from the liquid crystal compound in the liquid crystal alignment pattern of the second liquid crystal layer rotates by 180° in a plane,
the requirement 3: the liquid crystal compound in the second liquid crystal layer is aligned along one direction in a surface on the first liquid crystal layer side.

2. The optical laminate according to claim 1,
wherein a rotation angle of the optical axis derived from the liquid crystal compound in a thickness direction of the first liquid crystal layer is less than 360°.

3. The optical laminate according to claim 2,
wherein the requirement 1 or 2 is satisfied,
in a cross-sectional image obtained by observing a cross section of each of the first liquid crystal layer and the second liquid crystal layer taken in the thickness direction along the one direction with a scanning electron microscope, a plurality of pairs of bright lines and dark lines derived from the orientations of the optical axes are present along the one direction, and
the first liquid crystal layer and the second liquid crystal layer have a region where the pairs of bright lines and dark lines in the cross-sectional image are inclined at different inclination angles with respect to a normal line of an interface between the first liquid crystal layer and the second liquid crystal layer.

4. The optical laminate according to claim 2,
wherein, in a case where the length over which the orientation of the optical axis derived from the liquid crystal compound rotates by 180° in the plane is defined as a single period,
a length of the single period in the liquid crystal alignment pattern of the first liquid crystal layer gradually changes in the one direction, and
a length of the single period in the liquid crystal alignment pattern of the second liquid crystal layer gradually changes in the one direction.

5. The optical laminate according to claim 1,
wherein the first liquid crystal layer is a cholesteric liquid crystal layer.

6. The optical laminate according to claim 5,
wherein the requirement 1 or 2 is satisfied,
the second liquid crystal layer is a cholesteric liquid crystal layer, and
a helical pitch of a helical structure of a cholesteric liquid crystalline phase of the first liquid crystal layer and a helical pitch of a helical structure of a cholesteric liquid crystalline phase of the second liquid crystal layer are different from each other, or a rotation direction of the helical structure of the cholesteric liquid crystalline phase of the first liquid crystal layer and a rotation direction of the helical structure of the cholesteric liquid crystalline phase of the second liquid crystal layer are different from each other.

7. The optical laminate according to claim 6,
wherein, in a case where the length over which the orientation of the optical axis derived from the liquid crystal compound rotates by 180° in the plane is defined as a single period,
a length of the single period in the liquid crystal alignment pattern of the first liquid crystal layer gradually changes in the one direction, and
a length of the single period in the liquid crystal alignment pattern of the second liquid crystal layer gradually changes in the one direction.

8. The optical laminate according to claim 1,
wherein the requirement 3 is satisfied, and
the second liquid crystal layer is a λ/4 plate or a λ/2 plate.

9. A display device comprising:
the optical laminate according to claim 1.

10. A sensor comprising:
the optical laminate according to claim 1.

11. The display device according to claim 9,
wherein the display device is an augmented reality display device or a virtual reality display device.

12. A display device comprising:
the optical laminate according to claim 2.

13. A sensor comprising:
the optical laminate according to claim 2.

14. The display device according to claim 12,
wherein the display device is an augmented reality display device or a virtual reality display device.

15. A display device comprising:
the optical laminate according to claim 3.

16. A sensor comprising:
the optical laminate according to claim 3.

17. The display device according to claim 15,
wherein the display device is an augmented reality display device or a virtual reality display device.

18. A display device comprising:
the optical laminate according to claim 4.

19. A sensor comprising:
the optical laminate according to claim 4.

20. The display device according to claim 18,
wherein the display device is an augmented reality display device or a virtual reality display device.
